(19) United States
(12) Patent Application Publication
(10) Pub. No.: US 2010/0048752 A1
(43) Pub. Date: Feb. 25, 2010

(54) CROSSLINKED POLYMER COMPOSITION

(75) Inventors: Eric Vignola, Aliquippa, PA (US); Shelly Martel, Pittsburgh, PA (US); Edwin Niemann, Beaver, PA (US); Robert F. Hurley, Centerville, MA (US); Scott C. Smith, Osterville, MA (US)

Correspondence Address: NOVA Chemicals Inc.;Karen S. Lockhart, 1550 Coraopolis Heights Road, Moon Township, PA, 15108, US

(73) Assignees: NOVA CHEMICALS INC., Moon Township, PA (US); CELLECT LLC, St. Johnsville, NY (US)

(21) Appl. No.: 12/543,667

(22) Filed: Aug. 19, 2009

Related U.S. Application Data
(60) Provisional application No. 61/090,627, filed on Aug. 21, 2008.

(51) Int. Cl. C08J 9/228; C08L 25/02; C08L 23/04; C08L 31/04; C08L 33/02; C08L 33/12; C08L 9/00; C08L 53/00; C08K 5/26; C08K 5/23; C08K 5/24

(52) U.S. Cl. 521/139; 525/241; 525/240; 525/222; 525/221; 525/227; 525/232; 525/95; 525/88; 525/207; 524/528; 524/190; 524/189

(57) ABSTRACT

A polymer composition that includes a first polyolefin polymer and an interpenetrating network polymer. The interpenetrating network polymer includes a second polyolefin polymer present in an amount of from 10 percent by weight to 80 percent by weight, based on total weight of the interpenetrating network polymer, and a vinyl aromatic polymer present in an amount of from 20 percent by weight to 90 percent by weight, based on total weight of the interpenetrating network polymer. As initially provided in the polymer composition, the interpenetrating network polymer is substantially free of crosslinking. The polymer composition itself is at least partially crosslinked. An expandable polymer composition is provided that includes the polymer composition and an expansion agent, which can be expanded to form an expanded polymer composition that can have a density of from 16 to 400 Kg/m³.

### REFERENCE TO RELATED APPLICATION

This application claims the benefit of priority of U.S. Provisional Application Ser. No. 61/090,627 filed Aug. 21, 2008 entitled “Crosslinked Polymer Compositions,” which is herein incorporated by reference in its entirety.

### FIELD OF THE INVENTION

The present invention relates to a polymer composition that is at least partially crosslinked. More particularly, the polymer composition includes a first polyolefin polymer, and an interpenetrating network polymer. The interpenetrating network polymer, as initially provided in the polymer composition, is substantially free of crosslinking. The present invention also relates to an expandable polymer composition and an expanded (or foamed) polymer composition, each of which includes the polymer composition.

### BACKGROUND OF THE INVENTION

Polymer compositions based on polyolefins, such as polyethylene are known and are used to prepare foamed and non-foamed molded articles (e.g., foamed shaped articles and foamed sheets). To improve properties, such as toughness and thermal stability, polyolefin compositions, such as foamed polyolefin compositions are typically crosslinked. Crosslinked and foamed polyolefin compositions typically must have relatively high densities so as to provide desirable physical properties, such as high tensile strength, tear strength, puncture resistance and compressive strength. High densities, however, are generally accompanied by an increase in weight of the foamed polyolefin material for a particular application. An increase in weight of the foamed polyolefin material is often undesirable as it may result in, for example, increased fuel consumption in transportation related applications (e.g., shipping of wares packaged in polyolefin foam), or increased physical exertion in sports equipment applications (e.g., polyolefin foam padding and helmet liners).

U.S. Pat. Nos. 5,932,659; 6,531,520; 6,359,021; 6,214,894; and 6,004,647 describe crosslinked polymer blends that include a single-site catalyzed polyolefin resin, and a polyolefin that includes residues of ethylene and propylene. The polymer blends of the '659 patent are foamable.

U.S. Pat. No. 7,411,024 describes polymer compositions formed from a combination of interpolymer resin particles and polyethylene.

U.S. Pat. No. 3,959,189 describes a process for producing polyethylene resin particles that includes adding a cross-linking agent for the polyethylene prior to polymerization of a suspension and polymerizing polyethylene and then styrene, and impregnating a blowing agent in the polyethylene resin particles containing polymerized styrene resin.

U.S. Pat. No. 4,168,353 describes a process for producing foamable polyethylene resin particles that includes suspending polyethylene resin particles in an aqueous medium, adding styrene monomer and a catalyst for polymerizing the monomer to the suspension, polymerizing the monomer, and impregnating a blowing agent in the polyethylene resin particles containing the polymerized styrene resin.

U.S. Pat. No. 5,844,009 describes physically-blown low density polyethylene (LDPE) foams that are blends of an LDPE resin and a silane-grafted single-site initiated polyolefin resin.

U.S. Pat. No. 5,929,129 describes cross-linked polymeric foam compositions which include ethylene polymerized with at least one α-unsaturated C₃ to C₂₀ olefinic comonomer, and optionally at least one C₃ to C₂₀ polyene.

U.S. Pat. No. 5,883,144 describes polymeric foam compositions that utilize cross-linked polyolefin copolymers and show improvements in strength, toughness, flexibility, heat resistance and heat-sealing temperature ranges as compared to conventional low density polyethylene compositions. The polyolefins are essentially linear and include ethylene polymerized with at least one α-unsaturated C₃ to C₂₀ olefinic comonomer, and optionally at least one C₃ to C₂₀ polyene. The polyolefins are silane-grafted to enhance the physical properties and processibility of the resins.

A particular problem with the above-described polyolefin foam materials is that they provide less than optimum shock absorbing properties. This limits their effectiveness and use in a number of application areas.

It would be desirable to provide new crosslinked polyolefin based polymer compositions that can be expanded. In addition, it would be desirable that such expanded crosslinked polyolefin based polymer compositions provide a combination of desirable physical properties and lower densities, such as improved shock absorbing properties as an example.

### SUMMARY OF THE INVENTION

In accordance with the present invention, there is provided a polymer composition that includes a first polyolefin polymer and an interpenetrating network polymer. The interpenetrating network polymer includes a second polyolefin polymer present in an amount of from 10 percent by weight to 80 percent by weight, based on total weight of the interpenetrating network polymer, and a vinyl aromatic polymer present in an amount of from 20 percent by weight to 90 percent by weight, based on total weight of the interpenetrating network polymer. As initially provided in the polymer composition, the interpenetrating network polymer is substantially free of crosslinking. The inventive polymer composition is at least partially crosslinked.

There is also provided, in accordance with the present invention, an expandable polymer composition that includes the polymer composition as summarized above, which further includes an expansion agent. The expandable polymer composition is at least partially crosslinked.

There is further provided, in accordance with the present invention, an expanded polymer composition that includes the polymer composition as summarized above, in which the expanded polymer composition is at least partially crosslinked, and has a density of from 16 to 400 Kg/m³.

### BRIEF DESCRIPTION OF THE DRAWINGS

In describing the various features of the preferred embodiment, reference is made to the various Figures, in which like reference numerals indicate like features and wherein:

FIG. 1 is a perspective view of a yoga mat according to some embodiments of the invention;

FIG. 2 is a perspective view showing a tape according to some embodiments of the invention;

FIG. 3 is a top view of a preformed gasket according to some embodiments of the invention;

FIG. 4 is a profile view of the preformed gasket of FIG. 3;

FIG. 5 is a schematic cross-sectional view of a flooring system according to some embodiments of the invention;

FIG. 6 is a schematic cross-sectional view of a flooring system according to some embodiments of the invention;

FIG. 7 is a side view of the fabric-strip curtain for washing vehicles according to some embodiments of the invention;

FIG. 8 is a front view of a football player wearing a plurality of pads, with parts of his uniform broken away, the pads including various embodiments of the invention;

FIG. 9 is a side cross-sectional view of a protective pad according to some embodiments of the invention;

FIG. 10 is a perspective view of a helmet including foam compositions according to some embodiments of the invention, with parts broken away, positioned upon a wearer;

FIG. 11 is a perspective view of an interior or “foot-side” of a midsole member useful in sole structures according to some embodiments of the invention;

FIG. 12 is a perspective view of an exterior side of a midsole member useful in sole structures according to some embodiments of the invention; and

FIG. 13 is an exploded isometric view of body armor according to some embodiments of the invention.

### DETAILED DESCRIPTION OF THE INVENTION

As used herein and in the claims, the term “(meth)acrylic acid” and similar terms, means acrylic acid, methacrylic acid and combinations thereof. As used herein and in the claims, the term “esters of (meth)acrylic acid” and similar terms, such as “(meth)acrylate” mean esters of acrylic acid (or acrylates), esters of methacrylic acid (or methacrylates) and combinations thereof.

Other than in the operating examples, or where otherwise-indicated, all numbers or expressions referring to quantities of ingredients, reaction conditions, etc. used in the specification and claims are to be understood as modified in all instances by the term “about”.

The present polymer composition includes a first polyolefin polymer and an interpenetrating network polymer. The first polyolefin polymer may be selected from known polyolefin polymers. As used herein and in the claims, the term “polyolefin” and similar terms, such as “polyalkylene” and “thermoplastic polyolefin”, means polyolefin homopolymers, polyolefin copolymers, homogeneous polyolefins, heterogeneous polyolefins, and blends of two or more thereof. For purposes of illustration, examples of polyolefin copolymers include, but are not limited to, those prepared from ethylene and at least one of: one or more C₃-C₁₂ alpha-olefins, such as 1-butene, 1-hexene and/or 1-octene; vinyl acetate; vinyl chloride; (meth)acrylic acid; and esters of (meth)acrylic acid, such as C₁-C₈-(meth)acrylates.

The first polyolefin of the polymer composition of the present invention may be selected from heterogeneous polyolefins, homogeneous polyolefins, or combinations thereof. The term “heterogeneous polyolefin” and similar terms means polyolefins having a relatively wide variation in: (i) molecular weight amongst individual polymer chains (i.e., a polydispersity index of greater than or equal to 3); and (ii) monomer residue distribution (in the case of copolymers) amongst individual polymer chains. The term “polydispersity index” (PDI) means the ratio of M_{w}/Mₙ, where M_{w} means weight average molecular weight, and Mₙ means number average molecular weight, each being determined by means of gel permeation chromatography (GPC) using appropriate standards, such as polyethylene standards. Heterogeneous polyolefins are typically prepared by means of Ziegler-Natta type catalysis in heterogeneous phase.

The term “homogeneous polyolefin” and similar terms means polyolefins having a relatively narrow variation in: (i) molecular weight amongst individual polymer chains (i.e., a polydispersity index of less than 3); and (ii) monomer residue distribution (in the case of copolymers) amongst individual polymer chains. As such, in contrast to heterogeneous polyolefins, homogeneous polyolefins have similar chain lengths amongst individual polymer chains, a relatively even distribution of monomer residues along polymer chain backbones, and a relatively similar distribution of monomer residues amongst individual polymer chain backbones. Homogeneous polyolefins are typically prepared by means of single-site, metallocene or constrained-geometry catalysis. The monomer residue distribution of homogeneous polyolefin copolymers may be characterized by composition distribution breadth index (CDBI) values, which are defined as the weight percent of polymer molecules having a comonomer residue content within 50 percent of the median total molar comonomer content. As such, a polyolefin homopolymer has a CDBI value of 100 percent. For example, homogenous polyethylene/alpha-olefin copolymers typically have CDBI values of greater than 60 percent or greater than 70 percent. Composition distribution breadth index values may be determined by art recognized methods, for example, temperature rising elution fractionation (TREF), as described by Wild et al, Journal of Polymer Science, Poly. Phys. Ed., Vol. 20, p. 441 (1982), or in U.S. Pat. No. 4,798,081, or in U.S. Pat. No. 5,089,321.

In an embodiment of the present invention, the first polyolefin is a polyethylene. In accordance with the description provided herein with regard to the term “polyolefin”, the term “polyethylene” means polyethylene homopolymers, polyethylene copolymers, homogeneous polyethylenes, heterogeneous polyethylenes; blends of two or more such polyethylenes thereof; and blends of polyethylene with another polyolefin that is other than an elastomer (e.g., polypropylene).

Polyethylene copolymers from which the first polyolefin may be selected in the present invention typically include: at least 50 weight percent, and more typically at least 70 weight percent of ethylene monomer residues; and less than or equal to 50 weight percent, and more typically less than or equal to 30 weight percent of non-ethylene comonomer residues (e.g., vinyl acetate monomer residues). The weight percents in each case being based on total weight of monomer residues. Polyethylene copolymers may be prepared from ethylene and any monomer that is copolymerizable with ethylene. Examples of monomers that are copolymerizable with ethylene include, but are not limited to, C₃-C₁₂ alpha-olefins, such as 1-butene, 1-hexene and/or 1-octene; vinyl acetate; vinyl chloride; (meth)acrylic acid; and esters of (meth)acrylic acid.

In embodiments of the invention, the first polyolefin includes one or more polymers selected from homopolymers of any C₂-C₈ linear or branched α-olefin; copolymers of ethylene and C₃-C₈ α-olefins; copolymers of C₂-C₈ linear or branched α-olefins and vinyl acetate; copolymers of one or more C₂-C₈ linear or branched α-olefins and C₁-C₈ linear or branched alkyl esters of (meth)acrylic acid; and combinations thereof.

In particular embodiments of the invention, the first polyolefin can include homogeneous polyethylene, heterogeneous polyethylene, high density polyethylene (HDPE), low density polyethylene (LDPE), linear low density polyethylene (LLDPE), long chain branched polyethylene, short chain branched polyethylene, copolymers of ethylene and ethyl (meth)acrylate (EMA), copolymers of ethylene and vinyl acetate and combinations of such polymers.

In other particular embodiments of the invention, the first polyolefin can include a combination of two or more polymers selected from ethylene homopolymers, copolymers of ethylene and C₃-C₈ α-olefins, copolymer of ethylene and ethyl (meth)acrylate, copolymers of ethylene and vinyl acetate (EVA), and combinations thereof.

In further particular embodiments of the present invention, the first polyolefin is a polyethylene polymer that is selected from: low density polyethylene (LDPE); linear low density polyethylene (LLDPE); medium density polyethylene (MDPE); high density polyethylene (HDPE); a copolymer of ethylene and vinyl acetate; a copolymer of ethylene and butyl acrylate; a copolymer of ethylene and methyl methacrylate; a blend of polyethylene and polypropylene; a blend of polyethylene and a copolymer of ethylene and vinyl acetate; and a blend of polyethylene and a copolymer of ethylene and propylene.

In a particular embodiment, the first polyolefin polymer is prepared from an olefin monomer composition that includes ethylene monomer, and optionally a comonomer selected from alpha-olefin monomer other than ethylene, such as C₃-C₈ α-olefin monomer (e.g., propylene and/or butylene), vinyl acetate, C₁-C₂₀-(meth)acrylate, such as C₁-C₈-(meth)acrylate, and combinations thereof. Typically, ethylene monomer is present in the olefin monomer composition in an amount of at least 50 percent by weight, based on total weight of the olefin monomer composition.

In a further particular embodiment, the first polyolefin polymer is a single site catalyzed polyolefin polymer having a density of at least 0.930 g/cm³. The density of the single site catalyzed polyolefin may, for example, range from 0.930 to 0.940 g/cm³ inclusive of the recited values; or be equal to or greater than 0.940 g/cm³ (e.g., 0.948 g/cm³).

The single site polyolefin polymer, from which the first polyolefin may be selected, may be a single site catalyzed polyethylene polymer. The single site catalyzed polyethylene polymer may be prepared from those monomers as recited previously herein, such as from ethylene monomer and a comonomer selected from the group consisting of vinyl acetate, C₃-C₂₀ α-olefin, C₁-C₈-(meth)acrylate, maleic anhydride, dialkyl esters of maleic anhydride, vinyl aromatic monomer and combinations thereof. The comonomer from which the single site catalyzed polyethylene polymer may be prepared, may be more particularly selected from vinyl acetate and/or C₃-C₈ α-olefin.

In various embodiments of the invention, the first polyolefin has a melt index determined according to ASTM D 1238 (190° C./2.16 Kg) of at least about 0.1, in some cases at least about 0.2, in other cases at least about 0.25, in some instances at least about 0.3, in other instances at least about 0.35, in some situations at least about 0.4, in other situations at least about 0.45 and in particular cases at least about 0.5 g/10 minutes. Also, the melt index determined according to ASTM D 1238 (190° C./2.16 Kg) of the first polyolefin can be up to about 35, in some cases up to about 30, in other cases up to about 25, in some instances up to about 20, in other instances up to about 15, in some situations up to about 10, in other situations up to about 5 and in particular cases at least up to about 2 g/10 minutes. The melt index of the first polyolefin is varied based on the properties desired in the final polymer composition. The melt index of the first polyolefin can be any value, or range between any of the values recited above.

In particular embodiments of the invention, the first polyolefin has a melt index determined according to ASTM D 1238 (190° C./2.16 Kg) of less than 1, in some cases less than 0.95, in other cases less than 0.9 and at least 0.1 g/10 minutes, as determined according to ASTM D 1238 (190° C./2.16 Kg). In this particular embodiment, the melt index of the first polyolefin can be any value, or range between any of the values recited above.

The first polyolefin polymer is generally present in the polymer composition of the present invention in an amount of less than or equal to 90 percent by weight, typically less than or equal to 80 percent by weight, and further typically less than or equal to 70 percent by weight, based on the total weight of the polymer composition. The first polyolefin polymer is generally present in the polymer composition of the present invention in an amount of at least 30 percent by weight, typically at least 40 percent by weight, and further typically at least 50 percent by weight, based on the total weight of the polymer composition. The amount of first polyolefin polymer present in the polymer composition of the present invention may range between any combination of these upper and lower values, inclusive of the recited values. For example, the first polyolefin may be present in the polymer composition in an amount of from 30 to 90 percent by weight, typically from 40 to 80 percent by weight, and further typically from 50 to 70 percent by weight, based on the total weight of the polymer composition, inclusive of the recited values.

The polymer composition also includes an interpenetrating network polymer that comprises: from 10 to 80 percent, in some cases 20 to 80 percent, in other cases 30 to 80 percent, and in some instances 30 to 70 percent by weight of a second polyolefin polymer; and from 20 to 90 percent, in some cases 20 to 80 percent, in other cases 20 to 70 percent, and in some instances 30 to 70 percent by weight of a vinyl aromatic polymer, the percent weights in each case being based on the total weight of the interpenetrating network polymer. The vinyl aromatic polymer is formed (i.e., polymerized) substantially within the second polyolefin polymer in particulate form (i.e., while the second polyolefin polymer is in particulate form).

The second polyolefin polymer of the interpenetrating network polymer may be selected from one or more of those classes and examples of polyolefins as described previously herein with regard to the first polyolefin polymer. For example, the second polyolefin polymer may be selected from polyolefin homopolymers, polyolefin copolymers, homogeneous polyolefins, heterogeneous polyolefins, and blends of two or more thereof.

In an embodiment of the present invention, the second polyolefin is a polyethylene. In accordance with the description provided herein with regard to first polyolefin and the term “polyolefin”, the term “polyethylene” means polyethylene homopolymers, polyethylene copolymers, homogeneous polyethylenes, heterogeneous polyethylenes; blends of two or more such polyethylenes thereof; and blends of polyethylene with another polymer (e.g., polypropylene).

Polyethylene copolymers, from which the second polyolefin may be selected in the present invention typically include: at least 50 weight percent, and more typically at least 70 weight percent of ethylene monomer residues; and less than or equal to 50 weight percent, and more typically less than or equal to 30 weight percent of non-ethylene comonomer residues (e.g., vinyl acetate monomer residues). The weight percents in each case being based on total weight of monomer residues. Polyethylene copolymers may be prepared from ethylene and any monomer that is copolymerizable with ethylene. Examples of monomers that are copolymerizable with ethylene include, but are not limited to, C₃-C₁₂ α-olefins, such as 1-butene, 1-hexene and/or 1-octene; vinyl acetate; vinyl chloride; (meth)acrylic acid; and esters of (meth)acrylic acid.

Polyethylene blends from which the second polyolefin may be selected in the present invention typically include: at least 50 percent by weight, and more typically at least 60 percent by weight of polyethylene polymer (e.g., polyethylene homopolymer and/or copolymer); and less than or equal to 50 percent by weight, and more typically less than or equal to 40 percent by weight of another polymer, that is different than the polyethylene polymer (e.g., polypropylene). The weight percents in each case being based on total polymer blend weight. Polyethylene blends may be prepared from polyethylene and any other polymer that is compatible therewith. Examples of polymers that may be blended with polyethylene include, but are not limited to, polypropylene, polybutadiene, polyisoprene, polychloroprene, chlorinated polyethylene, polyvinyl chloride, styrene-butadiene copolymers, vinyl acetate-ethylene copolymers, acrylonitrile-butadiene copolymers, vinyl chloride-vinyl acetate copolymers, and combinations thereof.

In an embodiment of the present invention, the second polyolefin polymer is a polyethylene polymer that is selected from: low density polyethylene (LDPE); linear low density polyethylene (LLDPE); medium density polyethylene (MDPE); high density polyethylene (HDPE); a copolymer of ethylene and vinyl acetate; a copolymer of ethylene and methyl acrylate (EMA); a copolymer of ethylene and butyl acrylate; a copolymer of ethylene and methyl methacrylate; a blend of polyethylene and polypropylene; a blend of polyethylene and a copolymer of ethylene and vinyl acetate; and a blend of polyethylene and a copolymer of ethylene and propylene.

In a particular embodiment, the second polyolefin polymer is prepared from an olefin monomer composition that includes ethylene monomer, and optionally a comonomer selected from alpha-olefin monomer other than ethylene, such as: C₃-C₂₀ α-olefin monomer, such as C₃-C₈ α-olefin monomer (e.g., propylene and/or, butylene); vinyl acetate; C₁-C₂₀-(meth)acrylate, such as C₁-C₈-(meth)acrylate; and combinations thereof. Typically, ethylene monomer is present in the olefin monomer composition (from which the second polyolefin is prepared) in an amount of at least 50 percent by weight, based on total weight of the olefin monomer composition.

In a further embodiment of the present invention, the second polyolefin polymer, of the interpenetrating network polymer, is prepared from an olefin monomer composition that includes ethylene monomer (e.g., at least 50 percent by weight ethylene monomer, based on total weight of the olefin monomer composition), and vinyl acetate. More particularly, the second polyolefin polymer is a polyethylene polymer, which is a copolymer of ethylene and vinyl acetate containing ethylene monomer residues in an amount of from 75 weight percent to 99 weight percent, and vinyl acetate monomer residues in an amount of from 1 weight percent to 25 weight percent. The weight percents in each case being based on total weight of monomer residues. In a particular embodiment, the second polyolefin polymer is a polyethylene polymer, which is a copolymer of ethylene and vinyl acetate containing 95 percent by weight of ethylene monomer residues, and 5 percent by weight of vinyl acetate monomer residues, based in each case on total weight of monomer residues. As used herein and in the claims, the percent weight monomer residue values are substantially equivalent to the percent weight of corresponding monomers present within the olefin monomer composition from which the second polyolefin polymer is prepared.

The second polyolefin polymer is typically present in the particulate interpenetrating network polymer in an amount of less than or equal to 80 percent by weight, more typically less than or equal to 65 percent by weight, and further typically less than or equal to 50 percent by weight, based on total weight of the particulate interpenetrating network polymer. The second polyolefin polymer is typically present in the particulate interpenetrating network polymer in an amount equal to or greater than 10 percent by weight, more typically equal to or greater than 15 percent weight, and further typically equal to or greater than 20 percent by weight, based on total weight of the particulate interpenetrating network polymer. The amount of second polyolefin polymer present in the particulate interpenetrating network polymer of the present invention may range between any combination of these upper and lower values, inclusive of the recited values. For example, the second polyolefin polymer may be present in the particulate interpenetrating network polymer in an amount of from 10 to 80 percent by weight, more typically from 15 to 65 percent by weight, and further typically from 20 to 50 percent by weight, based on total weight of the particulate interpenetrating network polymer.

The particulate interpenetrating network polymer of the present invention also includes a vinyl aromatic polymer. As used herein and in the claims, the term “vinyl aromatic polymer” means vinyl aromatic homopolymers, vinyl aromatic copolymers and blends thereof.

The vinyl aromatic polymer may be prepared from one or more vinyl aromatic monomers, and optionally at least one comonomer that is not a vinyl aromatic monomer. In an embodiment, the vinyl aromatic polymer is prepared from a vinyl aromatic polymer monomer composition that includes: (i) a vinyl aromatic monomer present in an amount of from 70 percent by weight to 99 percent by weight (or 90 to 98 percent by weight, or 92.5 to 97.5 percent by weight), based on total weight of the vinyl aromatic polymer monomer composition; and (ii) a comonomer present in an amount of from 1 percent by weight to 30 percent by weight (or 2 to 10 percent by weight, or 2.5 to 7.5 percent by weight), based on total weight of the vinyl aromatic polymer monomer composition.

Vinyl aromatic monomers that may be used to prepare the vinyl aromatic polymer of the interpenetrating network polymer include those known to the skilled artisan. In an embodiment, the vinyl aromatic monomer is selected from styrene, alpha-methylstyrene, para-methylstyrene, ethylstyrene, chlorostyrene, bromostyrene, vinyltoluene, vinylbenzene, isopropylxylene and combinations thereof.

Comonomers that may be polymerized with the vinyl aromatic monomer(s) to form the vinyl aromatic polymer of the interpenetrating network polymer, include those known to the skilled artisan. Examples of suitable comonomers include, but are not limited to: acrylic acid; methacrylic acid; (meth)acrylates, such as C₁-C₂₀- or C₁-C₈-(meth)acrylates (e.g., butyl acrylate, ethyl acrylate, 2-ethylhexyl acrylate, methyl methacrylate, ethyl methacrylate, butyl methacrylate, and 2-ethylhexyl methacrylate); acrylonitrile; vinyl acetate; dialkyl maleates (e.g., dimethyl maleate and diethyl maleate); and maleic anhydride. The comonomer may also be selected from multi-ethylenically unsaturated monomers, such as dienes (e.g., 1,3-butadiene); di-(meth)acrylates of alkyleneglycols having one or more alkyleneglycol repeat units (e.g., ethyleneglycol di-(meth)acrylate, diethyleneglycol di-(meth)acrylate, and poly(ethyleneglycol) di-(meth)acrylate having 3 or more ethyleneglycol repeat units, such as 3 to 100 repeat units); trimethylolpropane di- and tri-(meth)acrylate; pentaerythritol di-, tri- and tetra-(meth)acrylate; and divinyl benzene. Multi-ethylenically unsaturated monomers are typically present in the vinyl aromatic polymer monomer composition in amounts of less than or equal to 5 percent by weight, and more typically less than or equal to 3 percent by weight, (e.g., from 0.5 to 1.5 or 2 percent by weight) based on total weight of the vinyl aromatic polymer monomer composition.

In an embodiment, the vinyl aromatic polymer is prepared from a vinyl aromatic polymer monomer composition that includes vinyl aromatic monomer (e.g., styrene) and at least one C₁-C₂₀-(meth)acrylate, such as at least one C₁-C₈-(meth)acrylate (e.g., butyl(meth)acrylate). In a particular embodiment, the vinyl aromatic polymer is prepared from a vinyl aromatic polymer monomer composition that includes styrene and butyl acrylate (e.g., 97 percent by weight styrene, and 3 percent by weight butyl acrylate, based on total monomer weight in each case).

The vinyl aromatic polymer is typically present in the particulate interpenetrating network polymer in an amount of less than or equal to 90 percent by weight, more typically less than or equal to 85 percent by weight, and further typically less than or equal to 80 percent by weight, based on total weight of the particulate interpenetrating network polymer. The vinyl aromatic polymer is typically present in the particulate interpenetrating network polymer in an amount equal to or greater than 20 percent by weight, more typically equal to or greater than 35 percent weight, and further typically equal to or greater than 50 percent by weight, based on total weight of the particulate interpenetrating network polymer. The amount of vinyl aromatic polymer present in the particulate interpenetrating network polymer of the present invention may range between any combination of these upper and lower values, inclusive of the recited values. For example, the vinyl aromatic polymer may be present in the particulate interpenetrating network polymer in an amount of from 20 to 90 percent by weight, more typically from 35 to 85 percent by weight, and further typically from 50 to 80 percent by weight, based on total weight of the particulate interpenetrating network polymer.

The second polyolefin polymer (e.g., a copolymer of ethylene and vinyl acetate) and the vinyl aromatic polymer (e.g., a copolymer of styrene and butyl acrylate) together form the particulate interpenetrating network polymer of the polymer composition of the present invention. Typically, the interpenetrating network polymer is prepared by polymerizing the vinyl aromatic polymer monomer composition substantially within previously formed/polymerized polyolefin particles. In general, polyolefin particles are infused or impregnated with the vinyl aromatic polymer monomer composition and one or more initiators, such as peroxide initiators. The vinyl aromatic polymer monomer composition is then polymerized. Based on the evidence at hand, and without intending to be bound by any theory, it is believed that polymerization of the vinyl aromatic polymer monomer composition occurs substantially within the polyolefin particles.

In an embodiment of the present invention, the particulate interpenetrating network polymer is prepared by a process comprising: (a) providing the polyolefin polymer in the form of a particulate polyolefin polymer; and (b) polymerizing the vinyl aromatic polymer monomer composition substantially within the particulate polyolefin polymer.

Formation of the particulate interpenetrating network polymer may be conducted under aqueous or non-aqueous conditions (e.g., in the presence of an organic medium). Typically, formation of the particulate interpenetrating network polymer is conducted under aqueous conditions.

When conducted under aqueous conditions, the polyolefin particles are typically first suspended in a combination of water (e.g., deionized water) and suspension agents. Numerous suspension agents that are known to the skilled artisan may be employed. Classes of suspension agents that may be used to form the interpenetrating network polymer, include, but are not limited to: water soluble high molecular weight materials (e.g., polyvinyl alcohol, methyl cellulose, hydroxylethyl cellulose, and polyvinylpyrrilodone); slightly or marginally water soluble inorganic materials (e.g., calcium phosphate, magnesium pyrophosphate, and calcium carbonate); and sulfonates, such as sodium dodecylbenzene sulfonate. In an embodiment, a combination of tricalcium phosphate and sodium dodecylbenzene sulfonate is used together as suspension agents in the preparation of the particulate interpenetrating network polymer.

The suspension agent may be present in an amount so as to effect suspension of the polyolefin particles within the aqueous medium. Typically, the suspension agent is present in an amount of from 0.01 to 5 percent by weight, and more typically from 1 to 3 percent by weight, based on the total weight of the water and suspension agent(s).

The polyolefin particles are generally added, with agitation, to a previously formed water and suspension agent composition. Alternatively, the polyolefin particles, water and suspension agent may be concurrently mixed together. The amount of water present, relative to the amount of polyolefin particles may vary widely. Enough water is present for purposes of effectively suspending the polyolefin particles, and allowing for the addition, infusion and polymerization of the vinyl aromatic polymer monomer composition. Typically, the weight ratio of water to polyolefin particles is from 0.7:1 to 5:1, and more typically from 3:1 to 5:1.

The weight ratio of water to particulate polymer material may change during the process of forming the particulate interpenetrating network polymer. For example, the weight ratio of water to polyolefin particles may initially be 5:1, and with the introduction and polymerization of the vinyl aromatic polymer monomer composition over time, the weight ratio of water to the forming/formed particulate interpenetrating network polymer may be effectively and correspondingly reduced (e.g., to 1:1).

The vinyl aromatic polymer monomer composition and initiators are typically next added to the aqueous suspension of particulate polyolefin. The initiator may be added pre-mixed with the vinyl aromatic polymer monomer composition, concurrently therewith, and/or subsequently thereto. If added separately from the vinyl aromatic polymer monomer composition, the initiators may be added alone or dissolved in an organic solvent, such as toluene or 1,2-dichloropropane, as is known to the skilled artisan. Typically, the initiator is pre-mixed with (e.g., dissolved into) the vinyl aromatic polymer monomer composition, and the mixture thereof is added to the aqueous suspension of polyolefin particles.

One or more initiators suitable for polymerizing the vinyl aromatic polymer monomer composition may be used. Examples of suitable initiators include, but are not limited to: organic peroxides, such as benzoyl peroxide, lauroyl peroxide, t-butyl perbenzoate, and t-butyl peroxypivalate; and azo compounds, such as azobisisobutylonitrile and azobisdimethylvaleronitrile.

Polymerization of the vinyl aromatic polymer monomer composition may also be conducted in the presence of chain transfer agents, which serve to control the molecular weight of the resulting vinyl aromatic polymer. Examples of chain transfer agents that may be used include, but are not limited to: C₂₋₁₅ alkyl mercaptans, such as n-dodecyl mercaptan, t-dodecyl mercaptan, t-butyl mercaptan, and n-butyl mercaptan; and alpha methyl styrene dimer.

The initiator is generally present in an amount at least sufficient to polymerize substantially all of the monomers of the vinyl aromatic polymer monomer composition. Typically, the initiator is present in an amount of from 0.05 to 2 percent by weight, and more typically from 0.1 to 1 percent by weight, based on the total weight of vinyl aromatic polymer monomer composition and initiator.

Polymerization of the vinyl aromatic polymer monomer composition within the polyolefin particles generally involves the introduction of heat into the reaction mixture. For example, the contents of the reactor may be heated to temperatures of from 60° to 120° for a period of at least one hour (e.g., 8 to 20 hours) in a closed vessel (or reactor) under an inert atmosphere (e.g., a nitrogen sweep), in accordance with art-recognized procedures. Upon completion of the polymerization, work-up procedures may include the introduction of one or more washing agents (e.g., inorganic acids), and separation of the particulate interpenetrating network polymer from the aqueous reaction medium (e.g., by means of centrifuging), in accordance with art-recognized methods.

As initially provided in the polymer composition of the present invention, the interpenetrating network polymer is substantially free of crosslinking. As used herein and in the claims, the term “substantially free of crosslinking” means the interpenetrating network polymer has a gel content of less than or equal to 1.5 percent by weight (e.g., from 0 to 1.5 percent by weight), based on the weight of the interpenetrating network polymer. Typically, the interpenetrating network polymer has a gel content of less than or equal to 0.8 percent by weight (e.g., 0 to 0.8 percent by weight), or less than or equal to 0.5 percent by weight (e.g., 0 to 0.5 percent by weight), based on the weight of the interpenetrating network polymer. Gel content values and the level of crosslinking typically have a direct relationship. More particularly, gel content values of lower magnitude are generally associated with lower levels of crosslinking (and accordingly lower values of percent crosslinking by weight). Gel content values may be determined in accordance with suitable art-recognized methods. As used herein and in the claims, with regard to the term substantially free of crosslinking, the gel content values are determined in accordance with American Society for Testing and Materials (ASTM) test number D 2765 (but using toluene rather than xylene).

To ensure that the interpenetrating network polymer is substantially free of crosslinking, formation of the second polyolefin polymer and the vinyl aromatic polymer (within the second polyolefin polymer) are each performed in the substantial absence of multi-functional initiators and/or multi-ethylenically unsaturated monomers. For example, polymerization of the vinyl aromatic polymer monomer composition within the polyolefin particles is performed in the substantial absence of organic peroxide based crosslinking agents, such as, di-t-butyl-peroxide, t-butyl-cumylperoxide, dicumyl peroxide, α,α-bis-(t-butylperoxy)-p-diisopropylbenzene, 2,5,-dimethyl-2,5-di-(t-butylperoxy)-hexyne-3,2,5-dimethyl-2,5-di-(benzoylperoxy)-hexane, t-butyl-peroxyisopropyl-carbonate; and multi-functional organic peroxide materials, such as polyether poly(t-butyl peroxycarbonate), commercially available under the tradename LUPEROX® JWEB50, Arkema Inc., Philadelphia, Pa.

The interpenetrating network polymer, in addition to being substantially free of crosslinking, typically has a VICAT softening temperature of from 90° C. to 115° C. (e.g., from 90° C. to 105° C.). The VICAT softening temperature is determined in accordance with ASTM D 1525 (rate B, loading 1). In addition to being substantially free of crosslinking, the interpenetrating network polymer also typically has a melt index of from 0.2 to 35 g/10 minutes, as determined in accordance with ASTM D 1238 (230° C./2.16 Kg).

The interpenetrating network polymer may have any suitable form when introduced into the polymer composition of the present invention. Typically, the interpenetrating network polymer is used in particulate form, in which case it is a particulate interpenetrating network polymer. The particulate interpenetrating network polymer may have a wide range of particle sizes and shapes. Typically, the particulate interpenetrating network polymer has an average particle size (as determined along the longest particle dimension) of from 0.2 to 10.0 mm, more typically from 1 to 8 mm, and further typically from 3 to 6 mm. The particulate interpenetrating network polymer may have shapes selected from spherical shapes, oblong shapes, rod-like shapes, irregular shapes and combinations thereof. More typically, the particulate interpenetrating network polymer has shapes selected from spherical shapes and/or oblong shapes. The particulate interpenetrating network polymer may have an aspect ratio of from 1:1 to 10:1 (e.g., from 1:1 to 5:1).

In an embodiment, the interpenetrating network polymer can be any of the particulate interpenetrating network polymers available commercially from NOVA Chemicals Inc. under the tradename IPN™ resin.

The interpenetrating network polymer of the polymer composition of the present invention may optionally include additives. Examples of additives include, but are not limited to: colorants (e.g., dyes and/or pigments); ultraviolet light absorbers; antioxidants; antistatic agents; fire retardants; fillers (e.g., clays); nucleating agents, typically in the form of waxes (e.g., polyolefin waxes, such as polyethylene waxes); and elastomers, including those described further herein with regard to the polymer composition, such as vinyl aromatic-alkyldiene block copolymers (e.g., styrene-butadiene-styrene (SBS), hydrogenated styrene-ethylene-butadiene-styrene (SEBS), and styrene-butadiene (SBR) block copolymers). Additives may be present in the interpenetrating network polymer in functionally sufficient amounts, e.g., in amounts independently from 0.1 percent by weight to 20 percent by weight, based on the total weight of the interpenetrating network polymer. The additives may be introduced at any point during formation of the interpenetrating network polymer, or any component thereof. For example, at least some of the additives may be introduced into the second polyolefin polymer during its polymerization, and/or after polymerization by melt blending (e.g., extrusion). Alternatively, at least some of the additives may be introduced during polymerization of the vinyl aromatic polymer monomer composition. Further alternatively, at least some of the additives may be introduced after polymerization of the vinyl aromatic polymer monomer composition (e.g., by means of melt compounding with the interpenetrating network polymer).

The interpenetrating network polymer is generally present in the polymer composition of the present invention in an amount of less than or equal to 70 percent by weight, typically less than or equal to 60 percent by weight, and further typically less than or equal to 50 percent by weight, based on the total weight of the polymer composition. The interpenetrating network polymer is generally present in the polymer composition of the present invention in an amount of at least 10 percent by weight, typically at least 15 percent by weight, and further typically at least 20 percent by weight, based on the total weight of the polymer composition. The amount of interpenetrating network polymer present in the polymer composition of the present invention may range between any combination of these upper and lower values, inclusive of the recited values. For example, the interpenetrating network polymer may be present in the polymer composition in an amount of from 10 to 70 percent by weight, typically from 15 to 60 percent by weight or 20 to 60 percent by weight, and further typically from 20 to 50 percent by weight or 25 to 50 percent by weight, based on the total weight of polymer composition, inclusive of the recited values.

The polymer composition of the present invention may optionally further include an elastomeric polymer. As used herein and in the claims, the term “elastomeric polymer” and similar terms, such as “elastomer,” means polymeric materials that possess rubbery or resilient properties (e.g., polymeric materials that substantially recover their original dimensions after extension or compression). The elastomeric polymer may be selected from, for example: natural rubbers; synthetic rubbers, such as, nitrile rubbers, butyl rubbers, polysulfide rubbers, silicone rubbers, halosilicone rubbers, polyurethane rubbers and thermoplastic olefin rubbers; ethylene-propylene-diene copolymers; polyisoprene; oxirane based elastomers; vinyl aromatic-alkyldiene block copolymers; polyhaloprenes; fluoropolymers and combinations thereof.

Vinyl aromatic-alkyldiene block copolymers from which the elastomeric polymer may be selected include, for example, block copolymers of styrene and butadiene, such as: styrene-butadiene diblock copolymers (also referred to as polystyrene-polybutadiene diblock copolymers or rubbers, SBR); styrene-butadiene-styrene (SBS) triblock copolymers (also referred to as polystyrene-polybutadiene-polystyrene triblock copolymers); and hydrogenated styrene-ethylene-butadiene-styrene (SEBS) block copolymers. Vinyl aromatic-alkyldiene block copolymers from which the elastomeric polymer may be selected include KRATON® polymers, which are commercially available from Kraton Polymers, LLC. A preferred class of vinyl aromatic-alkyldiene block copolymers from which the elastomeric polymer of the polymer composition may be selected are hydrogenated styrene-ethylene-butadiene-styrene (SEBS) block copolymers available from Kraton Polymers, LLC under the tradename KRATON G SEBS polymers.

In a particular embodiment, the elastomeric polymer is selected from one or more ethylene-propylene-diene copolymers/terpolymers (“EPDM”). The EPDM copolymer may contain, for example, ethylene in a range from 30 to 80 percent by weight, propylene in a range of from 10 to 70 percent by weight; and diene in a range of from 1 to 10 percent by weight, based on the total weight of the polymer. The diene of the EPDM may be selected from one or more known dienes used in the synthesis of EPDM. In an embodiment, the diene of the EPDM is ethylidene norbornene. An example of an EPDM copolymer that may be used in the polymer composition of the present invention is VISTALON® 2504 rubber, commercially available from ExxonMobil Chemical Corp., Irving, Tex.

In particular embodiments of the invention, the elastomeric polymer is selected from natural rubbers, nitrile rubbers, butyl rubbers, polysulfide rubbers, silicone rubbers, styrene-butadiene rubbers, halosilicone rubbers, polyurethane rubbers, thermoplastic olefin rubbers, ethylene-propylene-diene copolymers, polyisoprene, oxirane based elastomers, vinyl aromatic-alkyldiene block copolymers, styrene-ethylene-butylene-styrene block copolymers, polyhaloprenes, fluoropolymers and combinations thereof. A non-limiting example of an elastomeric polymer that can be used in the invention are those available under the trade name Engage® resins available from the Dow Chemical Company.

In another particular embodiment of the invention, the elastomeric polymer is selected from ethylene-propylene-diene copolymers, vinyl aromatic-alkyldiene block copolymers and combinations thereof.

The elastomeric polymer may be present in the polymer composition of the present invention in an amount of less than or equal to 50 percent by weight, typically less than or equal to 45 percent by weight, or more typically less than or equal to 40 percent by weight, based on the total weight of the polymer composition. The elastomeric polymer may also be present in the polymer composition in an amount of at least 5 percent by weight, typically at least 10 percent by weight, or more typically at least 15 percent by weight, based on the total weight of the polymer composition. The amount of elastomeric polymer present in the polymer composition of the present invention may range between any combination of these upper and lower values, inclusive of the recited values. For example, the elastomeric polymer may be present in the polymer composition in an amount of from 5 to 50 percent by weight, typically from 10 to 45 percent by weight, and more typically from 15 to 40 percent by weight, based on the total weight of the polymer composition, inclusive of the recited values.

The polymer compositions of the present invention are at least partially crosslinked. As used herein and in the claims, the term “at least partially crosslinked” means the polymer composition, or the expandable polymer composition or the expanded polymer composition has a crosslink density of at least 10 percent by weight, such as 10 to 100 percent by weight, 20 to 100 percent by weight, 30 to 90 percent by weight, 20 to 60 percent by weight, 30 to 60 percent by weight or 40 to 80 percent by weight, in each case based on total weight of the polymer composition, or the expandable polymer composition or the expanded polymer composition, as the case may be.

The level of crosslinking, and accordingly the crosslink density, may be selected based on how the polymer composition or the expanded polymer composition is used, or intended to be used in the case of the expandable polymer composition (e.g., as a thermoformable or thermoset polymer composition). For example, when the polymer composition is a thermoformable polymer composition, it may have a crosslink density of from 20 to 60 percent by weight, based on total weight of the polymer composition. In addition, when the polymer composition is a thermoset polymer composition, it may have a crosslink density of from 80 to 100 percent by weight, based on total weight of the polymer composition. As used herein and in the claims, the level of crosslinking and accordingly the term “crosslink density” with regard to the polymer composition, or the expandable polymer composition or the expanded polymer composition is determined by measuring the gel content of the polymer composition, or the expandable polymer composition or the expanded polymer composition, as the case may be. The gel content values of the polymer composition, or the expandable polymer composition or the expanded polymer composition of the present invention may be determined in accordance with art-recognized methods. The gel content of the polymer composition, the expandable polymer composition and the expanded polymer composition of the present invention is determined in each case in accordance with ASTM D 2765 (using toluene rather than xylene). As discussed previously herein with regard to the interpenetrating network polymer, gel content values and the level of crosslinking typically have a direct relationship. More particularly, gel content values of greater magnitude are generally associated with high levels of crosslinking (and accordingly percent crosslink density by weight values of greater magnitude).

The polymer composition of the present invention may be crosslinked by suitable methods selected from, for example, chemical crosslinking, physical crosslinking (e.g., via high energy irradiation) and combinations thereof. As used herein, the term “chemical crosslinking” means crosslinking that is achieved by means of a chemical crosslinking agent, such as certain organic peroxides. As used herein, the term “physical crosslinking” means crosslinking that is achieved by exposing the polymer composition to an external energy source (e.g., a high energy radiation source, such as an electron beam apparatus) that results in the formation of covalent bonds within, between and amongst the various polymer chains of the composition. Suitable techniques are disclosed, for example, in U.S. Pat. Nos. 5,883,144 and 5,844,009.

Chemical crosslinking may be used to achieve crosslinking when the polymer composition is in the form (or processed into the form) of films, sheets or three-dimensional bulk (e.g., shaped) articles. Physical crosslinking, such as by means of high energy irradiation, is typically employed to achieve crosslinking when the polymer composition is in the form (or processed into the form) of films or sheets. Crosslinking of the polymer composition (whether by chemical crosslinking and/or physical crosslinking means) results in the formation of covalent bonds between, within and amongst the various polymer chains of the polymer composition, thereby resulting in the formation of a three-dimensional crosslink network. While not intending to be bound by any theory, it is believed based on the evidence presently at hand, that crosslinking (whether by chemical crosslinking and/or physical crosslinking means) results in the formation of covalent bonds between, within and amongst: the first polyolefin polymer; the interpenetrating network polymer; and the optional elastomeric polymer (if present), thereby resulting in the formation of a three-dimensional crosslink network throughout the polymer composition.

Chemical crosslinking is typically achieved by including a crosslinking agent in the polymer composition. The crosslinking agent is usually activated by exposure to elevated temperature (e.g., by means of a convection oven and/or an infrared radiation source), actinic light (e.g., an ultraviolet light source) and/or high energy irradiation (e.g., an electron beam source). Typically, the crosslinking agent is a heat activated crosslinking agent that is activated by exposure to elevated temperature within the polymer composition. In an embodiment, the crosslinking agent is selected from at least one organic peroxide. Organic peroxides from which the crosslinking agent (or equivalently, the chemical crosslinking agent) of the polymer composition may be selected include, but are not limited to, dicumylperoxide, 2,5-dimethyl-2,5-di(t-butylperoxy)-hexane, 2,5-dimethyl-2,5-di(t-butylperoxy)hexyne-3,1,-bis(t-butylperoxy)-3,3,5-trimethyl cyclohexane, 2,4-dichlorobenzoyl peroxide, 2,5-dimethylhexane-2,5-di(peroxy)benzoate, 1,3-bis(t-butylperoxyisopropyl)benzene, 2,5-dimethyl-2,5-di(peroxybenzoyl)hexyne, 1,1-di-(t-butylperoxy)-cyclohexane, 2,2′-bis(t-butylperoxy)diisopropylbenzene, 4,4′-bis(t-butylperoxy)butylvalerate, t-butylperbenzoate, t-butylperterephthalate, t-butylperoxide and combinations thereof.

If present, the crosslinking agent is typically introduced during formation of the polymer composition along with the other components (e.g., the first polyolefin polymer, the interpenetrating network polymer, and the optional elastomeric polymer). The crosslinking agent is generally distributed substantially homogeneously and uniformly throughout the polymer composition. The crosslinking agent is generally present in the polymer composition in an amount of from 0.2 percent by weight to 10 percent by weight, more typically from 0.5 percent by weight to 5 percent by weight, and further typically from 1 percent by weight to 2.5 percent by weight, based on the total weight of the polymer composition (inclusive of the crosslinking agent).

In the case of chemical crosslinking, and in particular when a crosslinking agent is used, crosslinking of the polymer composition may be conducted: (i) during formation of the polymer composition (e.g., during melt compounding); and/or (ii) after formation of the polymer composition (e.g., by exposure to elevated temperature). When crosslinking is achieved by means of physical crosslinking means alone (i.e., in the absence of chemical crosslinking means, such as a crosslinking agent), crosslinking is usually achieved after formation of the polymer composition. For example, the polymer composition may be formed by melt compounding in an extruder, and then passed through a sheet (or film) die to form an uncrosslinked sheet (or film) that is cooled to ambient room temperature and collected on a roll. The uncrosslinked sheet may later be removed from the roll, physically crosslinked by exposure to high energy radiation (e.g., via an electron beam apparatus), and collected as a crosslinked sheet on a separate roll. Alternatively, the intermediate step of collecting uncrosslinked sheet on a roll (and optional shipping) may be dispensed with, and the sheet may be physically crosslinked by exposure to high energy radiation continuously as it emerges from the sheet die, thereby forming crosslinked sheet that may then be collected (e.g., on a roll).

The components of the polymer composition (e.g., first polyolefin, interpenetrating network polymer, optional elastomeric polymer, optional crosslinking agent, optional additives, and optional reinforcing agents) may be blended together by mixing the components thereof in the presence of one or more suitable solvents at elevated temperature. After obtaining a substantially homogenous mixture, the solvent may be removed under conditions of reduced pressure (e.g., by means of a thin film evaporator), thereby resulting in formation of the polymer composition.

More typically, the components of the polymer composition are blended together by art-recognized melt mixing, blending or compounding methods, in the substantial absence of solvent. Suitable art-recognized mixing apparatae, such as an internal mixer (e.g., a BANBURY mixer) and/or an extruder (e.g., single screw extruders, or co- or counter-rotating twin screw extruders), may be employed to blend the components of the polymer composition together.

The temperature(s) at which the components of polymer composition are blended together (e.g., via melt blending in an extruder) is typically selected so as to minimize: degradation of the polymer components; and activation of the crosslinking agents. Alternatively, the blending/mixing temperature may be selected so as to substantially concurrently effect crosslinking and expansion of the polymer composition.

The polymer composition may have any suitable form. For example, the polymer composition may have a form selected from, particulate forms, flake forms, pellet forms, three-dimensional shaped forms, film forms, sheet forms and combinations thereof. In a particular embodiment, the polymer composition is in the form of a polymer film or a polymer sheet. The films or sheets may be selected from single or multilayered films or sheets, in which at least one layer thereof comprises the polymer composition of the present invention. Multilayer films and sheets comprising the polymer composition of the present invention may further include: one or more nonpolymeric layers, such as metallic or metal foil layers; and/or one or more internal (e.g., interposed) and/or external adhesive layers.

The polymer composition, expandable polymer composition and expanded polymer composition of the present invention may each independently include one or more additives. Examples of additives include, but are not limited to: colorants (e.g., dyes and/or pigments); ultraviolet light absorbers; antioxidants (e.g., hindered phenols and phosphites); antistatic agents; fire retardants; fillers (e.g., clays); and processing oils (e.g., hydrocarbon oils, such as mineral oils). Additives may be present in the polymer composition, expandable polymer composition and expanded polymer composition in functionally sufficient amounts, e.g., in amounts independently from 0.1 percent by weight to 10 percent by weight, based on the total weight of the polymer composition, the expandable polymer composition or the expanded polymer composition, as the case may be.

The polymer composition, the expandable polymer composition and the expanded polymer composition of the present invention may each independently include one or more reinforcing materials. Examples of reinforcing materials that may be included in the compositions of the present invention include, but are not limited to, glass fibers, glass beads, carbon fibers, carbon nanotubes, carbon nanofibers, graphite, metal flakes, metal fibers, polyamide fibers (e.g., KEVLAR polyamide fibers), cellulosic fibers, nanoparticulate clays, talc and mixtures thereof. If present, the reinforcing material is typically present in a reinforcing amount, e.g., in an amount of from 5 to 70 percent by weight, 10 to 60 percent by weight, or 30 to 50 percent by weight (e.g., 40 percent by weight), based on the total weight of the polymer composition, the expandable polymer composition or the expanded polymer composition, as the case may be (inclusive of the reinforcing material). The reinforcing fibers, and the glass fibers in particular, may have sizings on their surfaces to improve miscibility and/or adhesion to the polymer materials into which they are incorporated, as is known to the skilled artisan.

The present invention also relates to an expandable polymer composition that includes the polymer composition described above and an expansion agent where the expandable polymer composition is at least partially crosslinked. As indicated, the polymer composition includes a first polyolefin polymer; an interpenetrating network polymer; and optionally an elastomer. The first polyolefin polymer, interpenetrating network polymer, and optional elastomer are in each case as described previously herein.

The expansion agent may be selected from one or more physical expansion agents and/or one or more chemical expansion agents and combinations thereof. As used herein and in the claims, the term “physical expansion agent” means an expansion agent that: remains substantially chemically unchanged (i.e., does not undergo a substantial change in chemical structure) upon expansion; and optionally changes phase upon expansion (e.g., being converted from a solid or liquid phase, into a gaseous phase). For purposes of illustration, in the case of carbon dioxide (CO₂) as a physical expansion agent, and in particular non-critical point or non-supercritical CO₂, upon expansion, the CO₂ typically transitions from a compressed state (e.g., when injected into the polymer composition within an extruder) to a non-compressed state (e.g., when the polymer composition including CO₂ mixed and/or dissolved therein emerges from an extruder, such as in the form of a sheet). During the transition from the compressed state to the non-compressed state, the polymer composition is expanded and the CO₂ remains substantially chemically unchanged (i.e., it is still CO₂). In the case of critical-point or supercritical CO₂, a concurrent liquid to gas phase change is believed to concurrently occur upon expansion. For purposes of further illustration, in the case of pentane as a physical expansion agent, upon expansion, the pentane is converted into gaseous pentane, but at the same time remains chemically unchanged (i.e., it is still pentane). Physical expansion agents are typically converted into a gaseous phase upon exposure to elevated temperature and/or reduced pressure.

Physical expansion agents that may be included in the expandable polymer compositions of the present invention may be selected from aliphatic hydrocarbons, cycloaliphatic hydrocarbons, halogenated hydrocarbons, water, CO₂, nitrogen (N₂) and combinations thereof. In a particular embodiment, the physical expansion agent of the expandable polymer composition is selected from propane, butane, pentane, hexane, cyclobutane, cyclopentane, methyl chloride, ethyl chloride, methylene chloride, trichlorofluoromethane, dichlorofluoromethane, dichlorodifluoromethane, chlorodifluoromethane, dichlorotetrafluoroethane, water, CO₂, N₂, and combinations thereof (including structural isomers thereof, e.g., n-pentane, iso-pentane, 1,1-dimethylpropane, etc.).

The amount of physical expansion present in the expandable polymer composition is generally selected so as to provide an expanded polymer composition having a desired density. Physical expansion agents, if used, are typically present in the expandable polymer composition of the present invention in an amount of from 0.5 percent by weight to 25 percent by weight, more typically from 2 percent by weight to 20 percent by weight, and further typically from 4 percent by weight to 15 percent by weight, based on the total weight of the expandable polymer composition (inclusive of the physical expansion agent).

As used herein and in the claims, the term “chemical expansion agent” means an expansion agent that changes phase upon expansion (e.g., being converted from a solid or liquid phase, into a gaseous phase), and which also undergoes a change in chemical structure (e.g., as the result of a decomposition reaction). Chemical expansion agents useful in the expandable polymer composition of the present invention, typically undergo a decomposition reaction upon exposure to elevated temperature and optionally reduced pressure, which results in the formation of a gaseous decomposition product (e.g., nitrogen, carbon dioxide and/or carbon monoxide). Chemical expansion agents that decompose to form inert gaseous decomposition products, such as nitrogen, are preferred since such inert gaseous decomposition products have a minimal environmental impact, and minimal detrimental impact on the polymer matrix of the polymer composition.

The chemical expansion agent may be selected from azo compounds, N-nitroso compounds, semicarbazides, sulfonyl hydrazides, carbonates, bicarbonates and combinations thereof. In an embodiment, the chemical expansion agent is selected from azodicarbonamide, p-p′-oxybis(benzene)-sulfonyl hydrazide, p-toluenesulfonyl hydrazide, p-toluenesulfonyl semicarbazide, 5-phenyltetrazole, ethyl-5-phenyltetrazole, dinitrosopentamethylenetetramine and combinations thereof. In a particular embodiment, the chemical expansion agent is selected from azodicarbonamide and/or p-p′-oxybis(benzene)sulfonyl hydrazide.

When chemical expansion agents are used, the expandable polymer compositions of the present invention may also include one or more activating agents. Activating agents typically serve to reduce the decomposition temperature of the chemical expansion agents, and thus lower the temperature at which expansion of the expandable polymer composition occurs. Activating agents that may be included in the expandable polymer composition include, but are not limited to, metal salts, such as zinc salts selected, for example, from zinc stearate and/or zinc oxide. If used, activating agents are typically present in an amount of from 0.05 percent by weight to 3 percent by weight, based on the total weight of the expandable polymer composition (inclusive of the activating agent).

As with the physical expansion agent, the amount of chemical expansion agent present in the expandable polymer composition is generally selected so as to provide an expanded polymer composition having a desired density. Chemical expansion agents, if used, are typically present in the expandable polymer composition of the present invention in an amount of from 1 percent by weight to 25 percent by weight, more typically from 2 percent by weight to 20 percent by weight, and further typically from 4 percent by weight to 15 percent by weight, based on the total weight of the expandable polymer composition (inclusive of the chemical expansion agent).

The expansion agent or agents are typically incorporated substantially concurrently during formation of the polymer composition, e.g., during melt compounding of the first polyolefin, the interpenetrating network polymer, and the optional elastomeric polymer. Alternatively, the expansion agent may be subsequently introduced into a previously formed polymer composition, e.g., by means of art-recognized infusion or imbibition methods. The previously formed polymer composition is typically in a form having a relatively large surface area, such as a particulate form, sheet form or film form. The previously formed polymer composition (e.g., in particulate, sheet or film form) and the expansion agent are typically contacted together under suitable conditions (e.g., elevated temperature and/or elevated pressure), and the expansion agent infuses into the polymer composition, thereby resulting in the formation of the expandable polymer composition of the present invention. When subsequently incorporated or introduced into a previously formed polymer composition, the expansion agent is typically a physical expansion agent (e.g., an aliphatic hydrocarbon, such as pentane).

When incorporated substantially concurrently during formation of the polymer composition, the expansion agent may be a physical and/or chemical expansion agent. More typically, when incorporated substantially concurrently during formation of the polymer composition (e.g., via melt compounding), the expansion agent is a chemical expansion agent (e.g., p-p′-oxybis(benzene)-sulfonyl hydrazide) in the substantial absence of physical expansion agents. The temperature (e.g., the melt compounding temperature) at which the expansion agent is concurrently incorporated during formation of the polymer composition is typically selected so as to substantially prevent expansion of the expansion agent, thus resulting in formation of the expandable polymer composition.

The expandable polymer composition is at least partially crosslinked. The level, determination, and methods of crosslinking of the expandable polymer composition are as described previously herein with regard to the polymer composition. For example, the expandable polymer composition may have a crosslink density of at least 10 percent by weight, such as 10 to 100 percent by weight, 20 to 100 percent by weight, 30 to 90 percent by weight, 20 to 60 percent by weight, 30 to 60 percent by weight or 40 to 80 percent by weight, based on total weight of the expandable polymer composition.

Crosslinking of the expandable polymer composition may be achieved by means of physical crosslinking (e.g., via exposure to high energy radiation) and/or chemical crosslinking (e.g., via crosslinking agents) in accordance with the description as provided previously herein with regard to the polymer composition. Crosslinking may be conducted prior to, during and/or after incorporation of the expansion agent into the polymer composition. In an embodiment, crosslinking is conducted after incorporation of the expansion agent into the polymer composition, in particular when the expandable polymer composition is in the form of an expandable polymer film or sheet. For example, a chemical expansion agent, such as p-p′-oxybis(benzene)sulfonyl hydrazide, may be incorporated during melt compounding (e.g., extrusion) of the polymer composition. An uncrosslinked film or sheet is formed by passing the extrudate, comprising the polymer composition and chemical expansion agent, through a film or sheet die, in accordance with art-recognized methods. The uncrosslinked film or sheet may then be subsequently physically crosslinked (e.g., by exposure to high energy radiation) thus resulting in formation of the expandable polymer composition (in film or sheet form) according to the present invention.

The expandable polymer composition may have any suitable form. For example, the expandable polymer composition may have a form selected from, particulate forms, three-dimensional shaped forms, film forms, sheet forms and combinations thereof. In a particular embodiment, the expandable polymer composition is in the form of an expandable polymer film or an expandable polymer sheet. The expandable films or sheets may be selected from single or multilayered films or sheets, in which at least one layer thereof comprises the expandable polymer composition of the present invention. Multilayer films and sheets comprising the expandable polymer composition of the present invention may further include: one or more nonpolymeric layers, such as metallic or metal foil layers; and/or one or more internal (e.g., interposed) and/or external adhesive layers.

Under suitable expansion conditions, which typically involve exposure to elevated temperature and/or reduced pressure, the expansion agent is activated (e.g., the expansion agent itself expands and/or generates a moiety that expands) and results in conversion of the expandable polymer composition into an expanded (or foamed) polymer composition. Accordingly, the present invention also relates to an expanded polymer composition that includes: a first polyolefin polymer; an interpenetrating network polymer; and optionally an elastomeric polymer. The first polyolefin polymer, interpenetrating network polymer, and optional elastomeric polymer are in each case as described previously herein.

The expanded polymer composition is at least partially crosslinked. The level, determination, and methods of crosslinking of the expanded polymer composition are as described previously herein with regard to the polymer composition. For example, the expanded polymer composition may have a crosslink density of at least 10 percent by weight, such as 10 to 100 percent by weight, 20 to 100 percent by weight, 30 to 90 percent by weight, 20 to 60 percent by weight, 30 to 60 percent by weight or 40 to 80 percent by weight, based on total weight of the expanded polymer composition.

Crosslinking of the expanded polymer composition may be achieved by means of physical crosslinking (e.g., via exposure to high energy radiation) and/or chemical crosslinking (e.g., via crosslinking agents) in accordance with the description as provided previously herein with regard to the polymer composition. The expanded polymer composition may be prepared from the expandable polymer composition of the present invention, in which case: at least some crosslinking is conducted prior to expansion of the expandable polymer composition; and optionally further crosslinking may be conducted during and/or after the expansion step. Alternatively, the expanded polymer composition may be prepared from an expandable polymer composition (as described previously herein) that is, however, substantially free of crosslinking, in which case crosslinking is performed substantially concurrently with and/or subsequent to expansion of the expandable and uncrosslinked polymer composition. Typically, the expanded polymer composition is prepared from the expandable polymer composition of the present invention, and substantially all crosslinking is completed prior to the expansion step.

The expanded polymer composition of the present invention, may have a wide range of densities, depending on the particular application in which the expanded polymer composition is intended to be used. The expanded polymer composition of the present invention typically has a density of from 16 Kg/m³ to 400 Kg/m³ (1 to 25 pounds/ft³), more typically from 24 Kg/m³ to 240 Kg/m³ (1.5 to 15 pounds/ft³), and further typically from 32 Kg/m³ to 192 Kg/m³ (2 to 12 pounds/ft³).

The expanded polymer composition may have any suitable form. For example, the expanded polymer composition may have a form selected from, three-dimensional shaped forms, film forms, sheet forms and combinations thereof. In a particular embodiment, the expanded polymer composition is in the form of an expanded polymer film or an expanded polymer sheet. The expanded films or sheets may be selected from single or multilayered films or sheets, in which at least one layer thereof comprises the expanded polymer composition of the present invention. Multilayer films and sheets comprising the expanded polymer composition of the present invention may further include: one or more nonpolymeric layers, such as metallic or metal foil layers; and/or one or more internal (e.g., interposed) and/or external adhesive layers. Expanded polymer compositions according to the present invention may have an open cell structure and/or a closed cell structure. More typically, the expanded polymer compositions of the present invention have a closed cell structure.

In embodiments of the invention, a cross-linked polymer foam structure is prepared by forming a foamable melt polymer material by blending the first polyolefin, interpenetrating network polymer, optional elastomeric polymer, and expansion agent and heating the mixture. Cross-linking is induced in the foamable melt polymer material and the foamable melt polymer material is expanded by exposing it to an elevated temperature to form the foam structure.

In particular embodiments of the invention, the expanded polymer composition can be made in bun stock form by mixing the first polyolefin, interpenetrating network polymer, optional elastomeric polymer, cross-linking agent, and expansion agent to form a slab, heating the mixture in a mold so the cross-linking agent can cross-link the polymer materials and the blowing agent can decompose, and expanding by release of pressure in the mold. Optionally, the bun stock formed upon release of pressure may be re-heated to effect further expansion.

In embodiments of the invention, the first polyolefin polymer, interpenetrating network polymer, and optional elastomeric polymer can be blended by mixing the polymers and any additives, while optionally heating the blend with mixing in a Banbury-type mixer, or an extruder to provide a homogeneous polymer blend. In particular embodiments of the invention, the interpenetrating network polymer and at least a portion of the first polyolefin polymer can be blended in an extruder and then blended with the remaining components. The temperature and pressure of the mixing are selected to avoid foaming. In many embodiments, mixing conditions are at pressures between 20 and 200 psi and temperatures between 150° F. and 280° F. Alternatively, when an extruder is used to mix the blend, the temperature is maintained below about 275° F. and the pressure is generally between 500 and 5000 psi depending on the die (i.e., a pressure of between 2000 and 3000 psi is used to extrude a flat sheet). In general, the treatment temperature is selected to avoid substantial decomposition of the foaming agent and the cross-linking agent. The polymer blend can be pre-formed for pressing, for example, as a sheet, by roll milling or extrusion. Alternatively, the blend can be pelletized.

In embodiments of the invention, the homogeneous polymer blend is used to produce polymer blend foams by compression molding, injection molding, or can be foamed as a sheet. In particular, the polymer blends are foamed by compression molding in a first pressing operation using a high tonnage hydraulic press at a temperature between 240° F. and 320° F. and a pressure of between 250 and 2500 psi for between 20 and 90 minutes. The polymer blend foam can be further expanded in a subsequent heating stage in an oven at a temperature between 300° F. and 380° F. for between 20 and 320 minutes or a second pressing operation in a medium tonnage hydraulic press at a temperature between 300° F. and 380° F. and a pressure of between 250 and 1500 psi for between 20 and 320 minutes. It has been observed that the pre-forming step helps degas the blend, the first pressing operation helps decrease the cell size and improve cell quality, and the second pressing operation helps prevent surface degradation and loss of material. The foams generally have average densities of between 1.5 and 25 pcf.

In embodiments of the invention, the polymer blend can be formed by pre-heating a section of a sheet to soften the blend and pressing the softened polymer blend in a mold. The polymer blend can be foamed if it contains a foaming agent and it is heated to induce foaming. The mold can be a single piece or a matching mold and can be vented. Forming and/or foaming a sheet in a mold in this way is one method of forming a gasket from the polymer blend.

In many embodiments of the invention, the processing time or cycle time required to produce the present expanded polymer composition is shorter than the time required to an expanded composition containing the same ingredients as the present expanded polymer composition except for the interpenetrating network polymer. In these embodiments, the process or cycle time required to produce the present expanded polymer composition is at least 5%, in some cases at least 10%, and in other cases at least 15% less than the time required to produce an expanded composition containing the same ingredients as the present expanded polymer composition except for the interpenetrating network polymer.

In embodiments of the invention, the polymer blend can be laminated to other materials or to itself by heat treatment of the laminate interface. Although adhesives can be applied, it is not necessary to use an adhesive to laminate the polymer blend.

In embodiments of the invention, the polymer blend, or foamed polymer blend, have good balance of tensile strength, shear strength, and cleavage strength. The tensile strength, elongation, compression resistance (compression deflection), compression set, and tear strength can be determined, for example, according to the procedure of ASTM D-3575. The flexibility and cushioning properties of the polymer blend is an important component of these properties.

In embodiments of the invention, the foamed polymer blend can be suitable for use in floatation devices. Floatation performance tests can be conducted according to the guidelines set forth by Underwriters Laboratories, Inc. in UL 1191, incorporated herein by reference. It is recommended that floatation materials generally have densities greater than 1 pound per cubic foot (pcf), a specific buoyancy of at least 58 pounds (lbs), a buoyancy retention factor of 98% for certain wearable devices (V factor) and 95% for cushions (C factor), a tensile strength of at least 20 pounds per square inch (psi), good flexibility (no cracking), and a compression deflection (25%) of at least 1 psi. The testing of the buoyancy retention further includes heat conditioning that involves treating the samples at 60° C. for 120 hours. The heat conditioning aspect of the test is essentially an elevated temperature creep test that probes the thermal stability of the material.

In embodiments of the invention, the thermal stability of the polymer blend can be measured from the floatation performance test, specifically the buoyancy retention factor, albeit indirectly. The thermal stability of the polymer blends relates to other applications. In particular, the polymer blends and foamed polymer blends are useful in automotive applications, particularly for making gaskets. The thermal stability of the materials in combination with the flexibility and formability make the polymer blends particularly suitable to automotive gasket applications.

In embodiments of the invention, the thermal stability of the polymer blends in gasket applications can be determined by monitoring their dimensional stability at elevated temperatures. For automotive applications, thermal stability can be tested by exposing a piece of the polymer blend to an elevated temperature for a particular amount of time and measuring the percent change in the dimensions of the piece. For example, a piece of a polymer blend (i.e., a 12 inches×12 inches×¼ inch piece of foam) can be heated to 158° F. for 24 hours. In other tests, for example, the pieces can be heated to 158° F. for 50 hours, 180° F. for 7 days, 257° F. for 30 minutes, 350° F. for 4 minutes, 130° F. for 66 hours, or 410° F. for 11 minutes. After cooling, the dimensions of the piece are calculated and the percent change in each dimension is calculated. Percent changes in dimensions that are less than about 8 percent, in many cases less than 5 percent, indicate polymer blends with adequate thermal stability for automotive gasket applications. Typical foam gaskets for automotive applications have foam densities between 2 and 14 pounds per cubic foot.

The expanded polymer compositions of the present invention can be used in impact energy management applications, such as transportation applications, packaging applications, and personal protective equipment applications. For example, the expanded polymer compositions of the present invention may used in the construction of internal cabin structures (e.g., dash boards, instrument panels and door liners), against which an occupant may be impacted (e.g., during a crash) in automobiles, trucks, aircraft and watercraft. The expanded polymer compositions may be incorporated as liners in personal protective equipment applications, such as personal sports, safety and military equipment. Examples of personal sports protective equipment that may include liners comprising the expanded polymer composition include, but are not limited to: sports helmets (e.g., hockey, batting, baseball, cricket, football, bicycle, motorcycle and racing helmets); body pads (e.g., shoulder pads, hip pads, thigh pads and tail bone pads); and shin guards (e.g., as used in baseball, cricket and soccer). Examples of personal safety protective equipment that may include liners comprising the expanded polymer composition include, but are not limited to, hard hats (e.g., construction helmets) and fireman's helmets. Examples of personal protective military equipment that may include liners comprising the expanded polymer composition include, but are not limited to, combat helmets, bullet proof vests and body armor.

The expanded polymer composition of the present invention may be used in construction and building applications. For example, sheets comprising the expanded polymer composition may be used as floor underlayments (e.g., beneath wood or ceramic floors), and in sound insulation applications (e.g., on walls, ceilings and/or floors).

Further examples of articles of manufacture that may include or be fabricated from the expanded polymer composition of the present invention include adhesive tapes and labels. The adhesive tapes include at least one layer comprising the expanded polymer composition, and typically further include one (in the case of one-sided tape) and two (in the case of two-sided tape) external adhesive layers. The labels include at least one layer comprising the expanded polymer composition, and may optionally further include: an external adhesive layer; one or more other expanded and/or non-expanded polymeric layers; and/or at least one non-polymeric layer, such as a metal or metal foil layer. Labels including at least one layer comprising the expanded polymer composition of the present invention also typically include indicia (e.g., letters, numbers, symbols and/or images) applied to one or more internal and/or external layers of the label.

Additional non-limiting examples of articles that may include or be fabricated from the expanded polymer composition of the present invention include toys, yoga mats, gaskets, and shoe parts, for example insoles, midsoles, and uppers.

As indicated above, the at least partially crosslinked expanded polymer compositions according to the invention can be used in various types of articles. Non-limiting particular examples of such articles are set forth below and in the drawings.

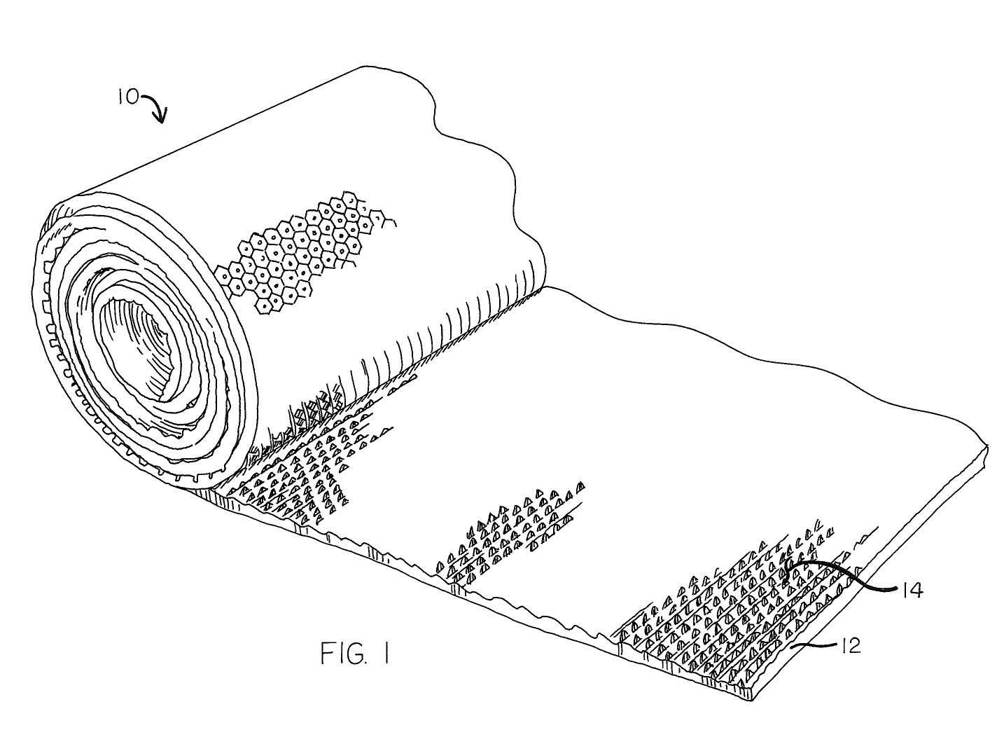

FIG. 1 shows embodiments of the invention, where the at least partially crosslinked expanded polymer compositions are used in the form of a yoga mat. In this embodiment, yoga mat 10 is made up of expanded polymer composition sheet 12 and can optionally include embossing 14 to minimize unwanted movement of yoga mat 10 while in use and improve the comfort when a user is on yoga mat 10. The presence of the interpenetrating network polymer in the polymer compositions improves the cushioning properties of yoga mat 10 making it more comfortable and less stressful on a user.

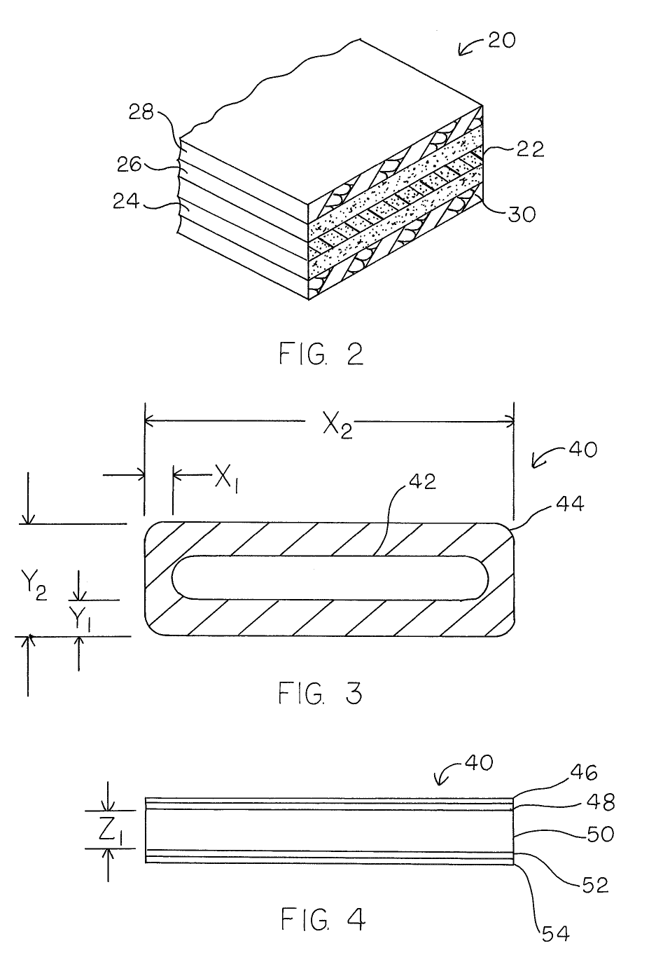

FIG. 2 shows embodiments of the invention, where the at least partially crosslinked expanded polymer compositions are used as a component in two-sided carpet tape. In this embodiment, carpet tape 20 (not drawn to scale) includes a first release film 28, a first adhesive layer 26, a core layer 22 made up of the present expanded crosslinked polymer compositions, a second adhesive layer 24, and a second release film 30. The core layer 22 is positioned between first adhesive layer 26 and second adhesive layer 24. First and second release films 28 and 30 are adjacent to and overlay a side of first and second adhesive layers 26 and 24 respectively. The presence of the interpenetrating network polymer in the polymer compositions improves the cushioning properties of carpet tape 20 making it more comfortable to walk on while in use.

FIGS. 3 and 4 show a gasket 40 according to embodiments of the invention. Gasket 40 is useful, as a non-limiting example, in plumbing applications. Gasket 40 is shown rectangular having outside dimensions X₂ and Y₂. Gasket 40 is shown having a width X₁ and Y₁, X₁ and Y₁ may be the same or different. Gasket 40 includes a compressible layer 50 made up of the present expanded crosslinked polymer compositions, a first adhesive layer 48 covered by a first release layer 46. Gasket 40 may include a second adhesive layer 52 covered by a second release layer 54. The compressible layer 50 having a thickness Z. In many embodiments, the thickness Z can range from 0.05-0.5 inches.

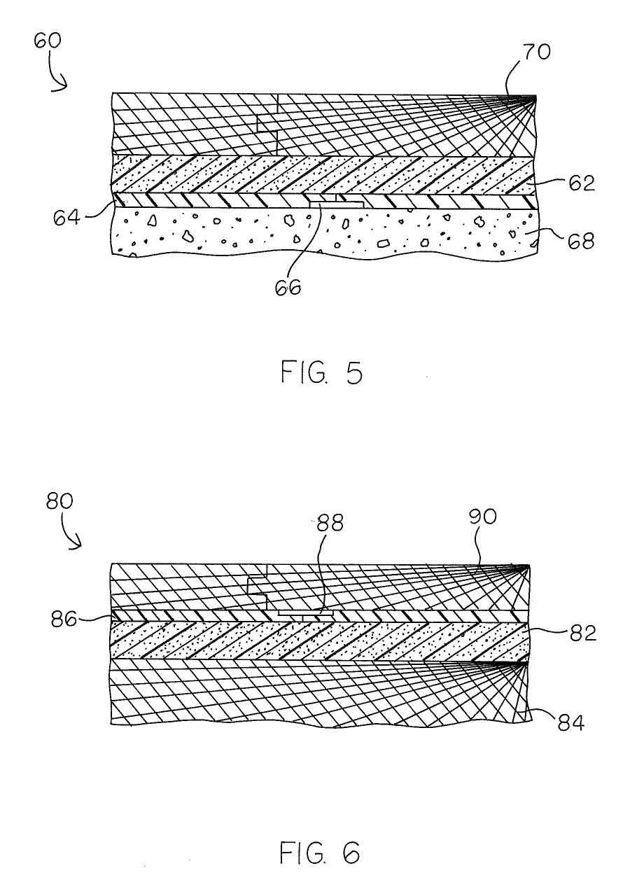

In embodiments of the invention, the present expanded crosslinked polymer compositions can be used as an underlayment between the subfloor and the finish flooring of a flooring system. As a non-limiting example shown in FIG. 5, flooring system 60 includes underlayment 62 installed between a concrete subfloor 68 and wood laminate finish flooring 70. Underlayment 62 ordinarily is positioned freely (i.e., using no adhesive or other attachment mechanism) on concrete subfloor 68 so that film 64 contacts the concrete subfloor. Webs of underlayment 62 can be installed so that the side edges of adjacent webs butt up against one another. During installation, adjacent webs of underlayment 62 can be joined together by a strip of tape 66. Planks of laminate wood flooring 70 can be positioned on underlayment 62 in a free-floating manner so that the planks rest on a surface of underlayment 62. Adjacent planks 70 can be glued or otherwise joined together using a conventional tongue-in-groove arrangement, but the planks are not adhered to underlayment 62.

Another non-limiting example of a flooring system in accordance with embodiments of the invention is shown in FIG. 6. In the illustrated flooring system 80, underlayment 82 is installed between wood subfloor 84 and the planks 90 of wood laminate finish flooring. The flooring system in accordance with this arrangement is similar to that shown in FIG. 5. However, rather than orienting underlayment 82 so that film 86 contacts the subfloor, in this installation it is oriented so a surface of underlayment 82 contacts the wood subfloor 84 and film 86 faces away from the subfloor. The planks 90 of laminate wood flooring may be positioned on underlayment 82 in a free-floating manner so that the planks rest on film 86. During installation, adjacent webs of underlayment 82 can be joined together by a strip of tape 88.

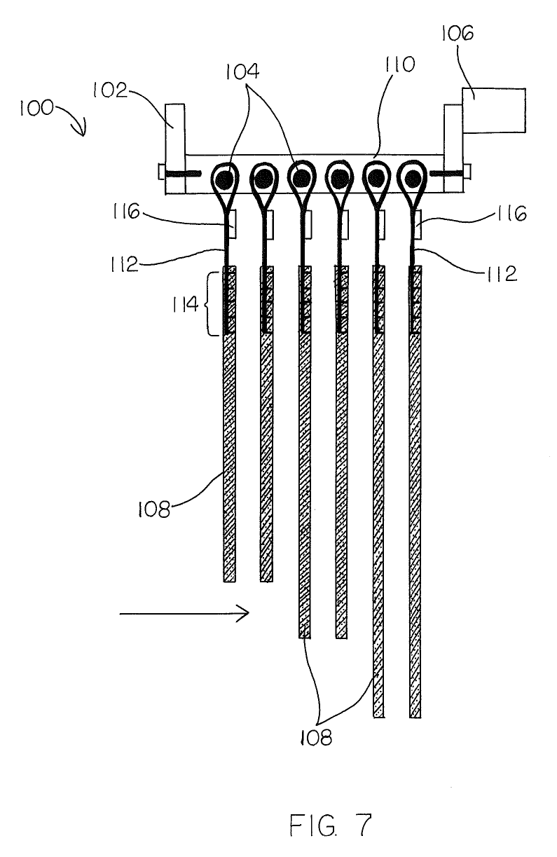

Embodiments of the invention shown in FIG. 7 are directed to a fabric-strip curtain 100 for car wash installations according to the invention. The direction in which the vehicles are towed through the car wash installation is indicated by the arrow. Above the vehicles to be washed, a framework 102 is arranged, on which a plurality of support bars 104 that run crosswise to the towing direction are attached. The framework 102 and thereby the support bars 104 are excited to move back and forth by means of a drive 106. A plurality of cleaning strips 108, made of the present expanded crosslinked polymer compositions, is hung on each support bar 104, next to one another. Loops 110 affixed at the top end of the cleaning strips, which encompass the support bar 104, in each instance, serve for this purpose. The loops are formed by attachment strips 112, which extend the cleaning strips 108 towards the top. For this purpose, the strips 112 are permanently sewn to the cleaning strips 108 in an attachment region 114. Each attachment strip 112 has an attachment element 116, with which the free end of the attachment strip 112 is detachably affixed above the attachment area 114 of the cleaning strip 108. In this way, the loops 110 are formed, which encompass the support bar 104 and which can be opened at any time, because of the detachable attachment, in order to be able to remove and replace individual cleaning strips 108.

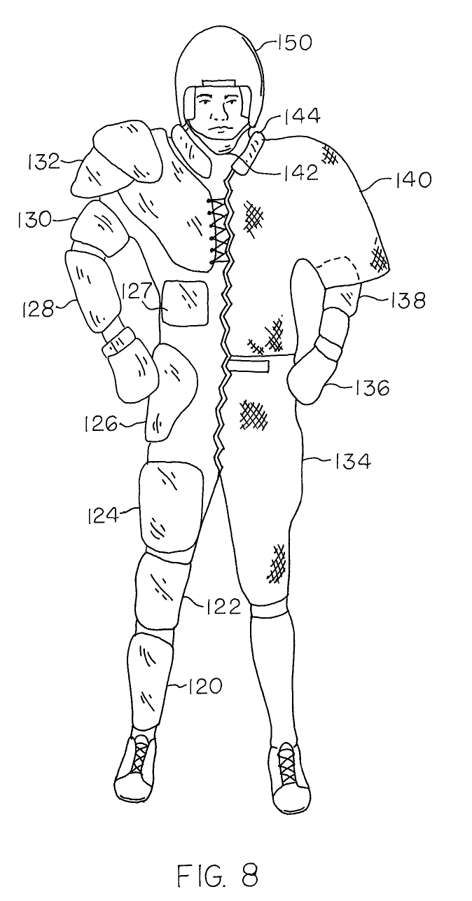

Embodiments of the invention shown in FIG. 8, a front or anterior view of a football player, include various types of protective padding that contains the present expanded crosslinked polymer compositions. The football player is shown wearing a helmet 150, a uniform 140 with parts broken away, and a plurality of guards or pads. Shown are shin guard 120, knee pad 122, thigh pad 124, hip pad 126, rib pad 127, shoulder pad 132, elbow pad 138, glove 136, forearm pad 128, biceps pad 130, neck pad 144, and chin strap 142. All of the aforementioned guards, pads, and other articles of apparel and protective equipment can be made to include the present expanded crosslinked polymer compositions for effecting a comfortable fit.

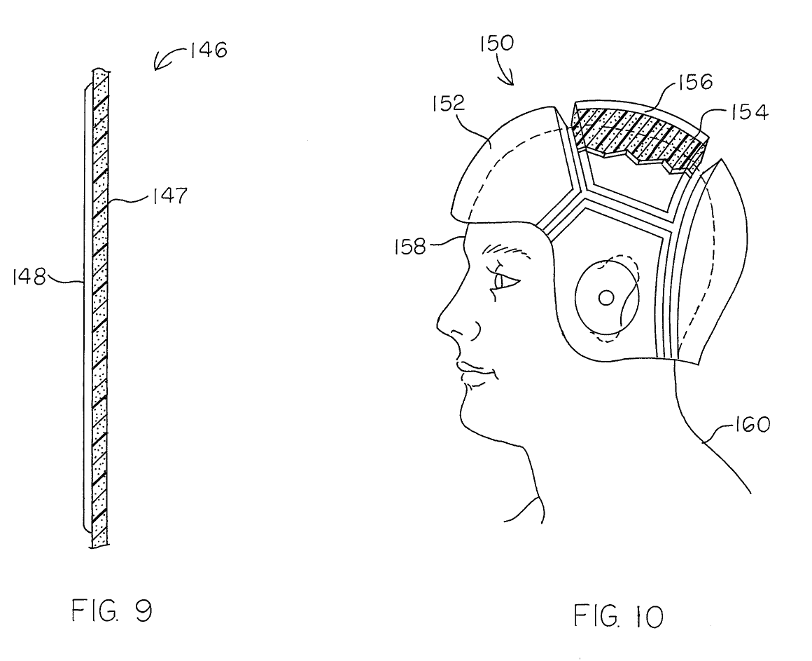

Further to the embodiments shown in FIG. 8, many of the pads and protective equipment can be constructed as shown in FIG. 9, which is a side cross-sectional view of a protective pad 146. As shown, protective pad 146 includes the present expanded crosslinked polymer compositions shown as foam layer 147 and a relatively rigid and relatively thin plastic layer 148.

FIG. 10 is a perspective view of helmet 150 cut away to show the present expanded crosslinked polymer compositions as a foam layer 154 positioned upon a wearer's head 158. It can be advantageous that helmet 150 be made having several different foam layer portions, which generally imitate the position of the major bones of the skull. As a non-limiting example a parietal foam portion 152 protecting the top of the head 156, and a frontal foam portion 52 protecting the front of the head 158. When helmet 150 extends near or below the position of the ear, it can sometimes be advantageous that an aperture or opening be provided so that the wearer's 160 hearing will not be significantly impaired. The aforementioned configuration of the helmet 150 facilitates conformance to the unique anatomical features of a wearer's head 158, due to the fact that the junction points between the respective foam layer portions are located proximate the various sutures of the skull.

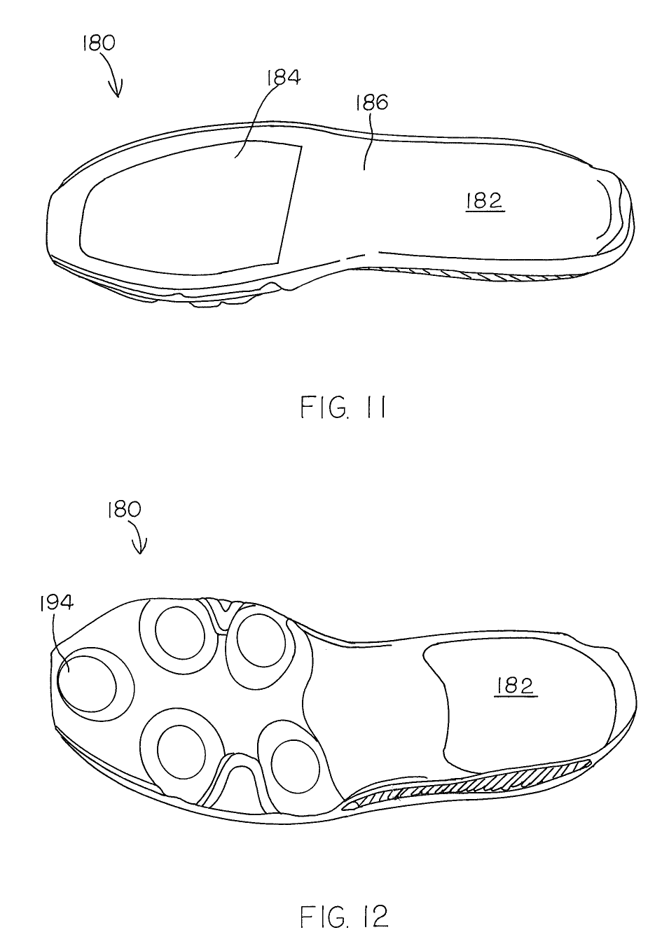

FIGS. 11 and 12 illustrate an example of a portion of a sole structure for an article of footwear (e.g., athletic footwear), namely, an example midsole member 180. This midsole member 180, which includes the present expanded crosslinked polymer compositions, is one of the primary sole structure elements that attenuates ground reaction forces. In particular embodiments, the midsole member 180 is constructed completely from the present expanded crosslinked polymer compositions. Midsole member 180 can include a forefoot portion 194, an arch portion 186, and a rearfoot portion 182 that correspond to various areas of a wearer's foot. Midsole structure can be fixed or held to the other portions of an overall sole or shoe structure in any suitable or desired manner without departing from this embodiment of the invention, including through the use of cements, adhesives, seal structures, retaining elements, mechanical connectors, or the like, including through the use of conventional connection techniques known and used in the art.

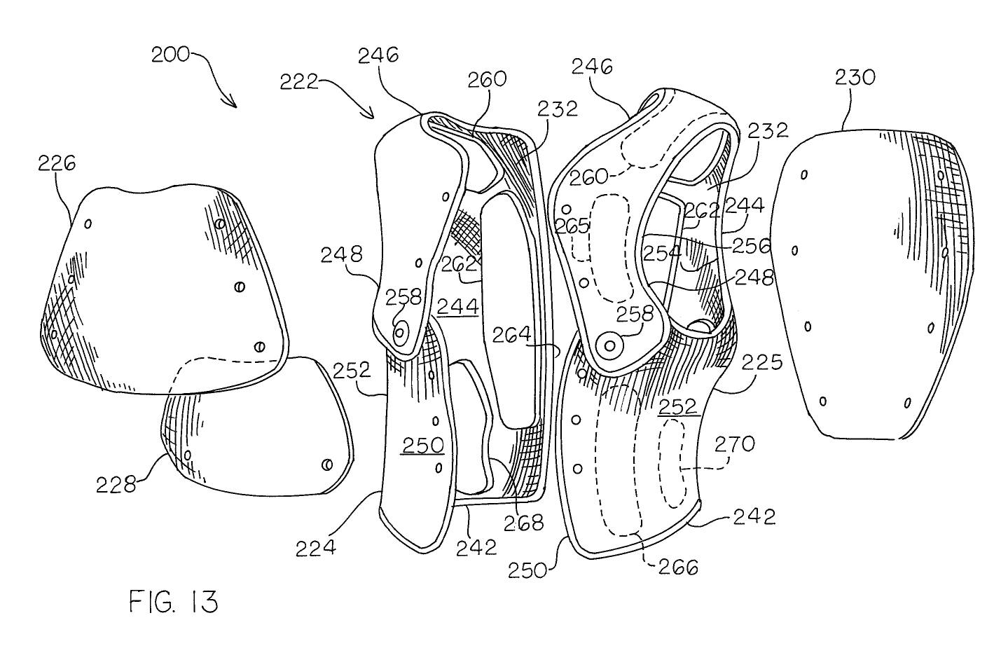

Some embodiments of the invention provide novel body armor articles as shown in FIG. 13. Body armor 200 according to these embodiments includes a soft armor vest 222 which has a right vest section 224 and a left vest section 225. The vest sections 224 and 225 are connected by rigid hard armor plates. The plates include two front plates: an upper breast plate 226 which overlaps a lower abdomen plate 228; and a back plate 230. A system 232 of foam pads, made from the present expanded crosslinked polymer compositions, is affixed to the inside of each vest section 224 and 225. The system of pads 232 spaces the vest 222 from the wearer, such that a plurality of air channels are defined between the wearer and the soft armor. The vest sections 224 and 225 are fabricated of multiple layers of ballistic fabric material.

Each vest section 224 and 225 has a back panel 244 which is positioned rearwardly of the wearer and which is connected by a shoulder section 246 to a breast flap 248. A torso segment 250 is connected by a side section 252 to the back panel 244. The torso segment 250 and the breast flap 248 define the front panels of the vest sections. The breast flap 248, the shoulder section 246, the back panel 244, and the torso segment 250 have an outer edge 254 which delineates an armhole 256 through which the wearer's arm extends.

The lower portion of the breast flap 248 can be secured or sewn to the upper portion of the torso segment 250 or they can be pivotably connected at a rotatable joint 258.

Each of the pads 260, 262, 265, 266, 268 and 270 of the pad system is formed of an open mesh fabric which encloses a closed cell foam resilient block made of the present expanded crosslinked polymer compositions. The open mesh fabric can be a 3D spacer fabric, or, alternatively, a closed smooth surface nylon or cotton, a wicking material, or a low friction nylon material. Alternatively, the foam blocks can be enclosed in leather, or may be exposed without any enclosure.

The pad system for each vest section 224 and 225 includes multiple repositionable pads provided with fastening means for adjustable positioning on the interior surface of the vest sections. In some embodiments, each pad is provided with one part of a hook and loop fastener system. Other readily positionable fastening system can also be used. The pad system can include a shoulder pad 260 which extends from the back panel 244 along the shoulder section 246 to the breast flap 248; an upper back pad 262 which extends vertically in the vicinity of the rear margin 264 of the back panel; an upper front pad 265 on the breast flap 248; a lower front pad 266 on the torso segment 250; and a lower back side pad 268 and front side pad 270 on the side section 252.

Body armor 200 is typically adequate for dealing with handgun rounds, fragmentation rounds from a grenade or mortar or other low velocity, subsonic projectile threats. The cushioning and shock attenuating properties of the present expanded crosslinked polymer compositions make body armor 200 particularly suitable for such uses.

The present invention will further be described by reference to the following examples. The following examples are merely illustrative of the invention and are not intended to be limiting. Unless otherwise indicated, all percentages are by weight.

### EXAMPLES

In the following examples, the starting materials used are coded in the tables below as follows:
ZNPE—polyethylene LA0219-A, NOVA Chemicals Corp., Calgary, Alberta, CA
SSCPE—polyethylene FPs-317A, NOVA Chemicals Corp., Calgary, Alberta, CA
LDPE—polyethylene 1076, Flint Hills Resources LLC, The Woodlands, Tex.
LLDPE—polyethylene LA-0218-A, NOVA Chemicals Corp., Calgary, Alberta, CA
EPDM—Royalene® 511, Chemtura Corp., Middlebury, Conn.
SEBS—Kraton-G-1657, Kraton Polymers U.S. LLC, Houston, Tex.
EMA—EMAC2205, Westlake Polymers LP, Houston, Tex.
POE—polyethylene elastomer Engage® resin 8452, Dow Chemical Co., Midland, Mich.
EVA—ethylene-vinyl acetate copolymer, 1903, Huntsman Corp., Odessa, Tex.
IPN30— interpolymer containing 30% ethylene-vinyl acetate copolymer (EVA)/70% (96.7/3.3 styrene/butyl acrylate copolymer) prepared according to Example 1 of U.S. Pat. No. 7,411,024.
IPN50— interpolymer containing 50 wt. % ethylene-vinyl acetate copolymer (EVA)/50 wt. % polystyrene prepared according to Example 1 of U.S. Pat. No. 7,411,024.
IPN70— interpolymer containing 70% EVA/30% polystyrene prepared according to Example 1 of U.S. Pat. No. 7,411,024.
IPN73— interpolymer containing 30% EVA/70% (90/10 styrene/butyl acrylate copolymer) prepared according to Example 1 of U.S. Pat. No. 7,411,024.
FA—blowing agent-Azodicarbonamide
ANTIOX—antioxidant—ETHANOX® 310, Albemarle Corporation, Baton Rouge, La.
OX—crosslinking agent—Perkadox® 40KE Akzo Chemie Nederland B.V., Amersfoort, the Netherlands

The following test methods were used to evaluate the various samples. Where used, MD denotes machine direction and TD denotes the transverse direction perpendicular to the machine direction.
Density—ASTM D-3575-91
Tensile Strength—ASTM 412 as referenced in ASTM D-3575-91
Compression-Deflection (25 and 50% C-D)—ASTM D-3575-91
Tear—ASTM D 624-73 as referenced in ASTM D-3575-91

### Example 1

The samples in the following table were prepared as described below and demonstrate expanded polymer compositions according to the invention where the composition of the interpenetrating network polymer is varied.

More particularly, the polymer blends were generally prepared by mixing the components in a batch operation as described above. The batches were weighed and segmented into sequential additions in the proportions show in the table below. A Banbury-type mixer was used for mixing in the various ingredients. The mixing is accomplished with counter rotating rotors contained within a closed chamber. A port on top of the chamber can be opened for addition of components. The opening is sealed for mixing with a pressurized hydraulic ram. The resultant pressure holds the material inside the chamber. The pressure further assists the rotors in softening, melting, plasticating, fusing, and blending the components which was accomplished by the heat that is provided to the chamber and the rotors and shear heat that is generated by the working of the material in the mixer. Various operations, such as scrape down or addition of other components, were carried out at different pre-designated temperatures. Generally the mixing temperature increased from about 245° F. to about 285° F. At the conclusion of the addition and mixing of all components, the completed polymer blend was removed from the mixer.

Once the polymer blend was mixed, it was generally pre-formed before foaming. A calendar heated to approximately 270° F. was used to prepare a pre-form for the pressing operation. The pre-form was roll milled in a two roll mill to form a sheet. Once the polymer blend was pre-formed, it was transported to a high tonnage press for expansion to a foam.

The pre-formed polymer blend was inserted into a picture frame type of mold in a high tonnage hydraulic press. The mold was one of many daylights of a multiple cavity high tonnage hydraulic press. Once all pre-forms were inserted into the molds, the press was closed. The pre-formed polymer blend was put under approximately 2000 psi of pressure and heated for approximately 50 minutes at 305° F. Upon release at the end of the heating period, the material was partially cross-linked and partially expanded. The partially expanded polymer blend was then transported to a low tonnage hydraulic press for final expansion of the foam.

The partially cross-linked and expanded pre-formed polymer blend was placed into a large mold cavity of a low tonnage hydraulic press and was further heated for 15 to 60 minutes at 325° F. under approximately 900 psi. Following the completion of the heating period, the material was cooled and allowed to normalize to room temperature. Once foamed, the polymer blend was ready for further fabrication or skiving.

| | Sample 1 | Sample 2 | Sample 3 | Sample 4 |
|---|---|---|---|---|
| ZNPE (pph) | 60 | 60 | 60 | 60 |
| IPN30 (pph) | | | | 40 |
| IPN50 (pph) | 40 | | | |
| IPN70 (pph) | | 40 | | |
| IPN73 (pph) | | | 40 | |
| FA (pph) | 16.5 | 16.5 | 16.5 | 16.5 |
| ANTIOX (pph) | 0.2 | 0.2 | 0.2 | 0.2 |
| Zinc oxide (pph) | 0.22 | 0.22 | 0.22 | 0.22 |
| Process Oil | 0.3 | 0.3 | 0.3 | 0.3 |
| OX (pph) | 1.0 | 1.0 | 1.0 | 1.0 |
| Color concentrate | 2.0 | 2.0 | 2.0 | 2.0 |
| Density (pcf) | 1.5 | 1.5 | 1.4 | 1.5 |
| Tensile (psi) | 22 | 23 | 22 | 30 |
| Elongation (%) | 92 | 156 | 63 | 54 |
| 25% C-D (psi) | 4.9 | 4.7 | 4.0 | 6.5 |
| 50% C-D (psi) | 10.3 | 11.7 | 7.5 | 13.9 |
| Tear (pli) | 4 | 5 | 3 | 4 |

The data demonstrate the desirable combination of physical properties obtained using the foamed polymer composition according to the invention.

### Example 2

The samples in the following table were prepared as in Example 1 and compare the properties of expanded polymer composites according to the invention with expanded polyethylene foams.

| | Sample 5 | Sample 6 | Sample 7 |
|---|---|---|---|
| ZNPE (pph) | 100 | 90 | 60 |
| IPN30 (pph) | | 10 | 40 |
| FA (pph) | 16.5 | 16.5 | 16.5 |
| ANTIOX (pph) | 0.2 | 0.2 | 0.2 |
| Zinc Oxide (pph) | 0.22 | 0.22 | 0.22 |
| Process Oil | 0.3 | 0.3 | 0.3 |
| OX (pph) | 1.9 | 1.4 | 1.0 |
| Color concentrate | 2.0 | 2.0 | 2.0 |
| Density (pcf) | 1.6 | 1.5 | 1.5 |
| Tensile (psi) | 30 | 26 | 30 |
| Elongation (%) | 246 | 142 | 54 |
| 25% C-D (psi) | 5.6 | 5.9 | 6.5 |
| 50% C-D (psi) | 12.8 | 13.0 | 13.9 |
| Tear (pli) | 6 | 5 | 4 |

The data demonstrate the desirable combination of physical properties obtained using the foamed polymer composites according to the invention.

### Example 3

The samples in the following table were prepared as in Example 1 and demonstrate the effect of the interpenetrating network polymer on expanded polymer compositions according to the invention containing a blend of polyethylene and SEBS.

| | Sample 8 | Sample 9 | Sample 10 |
|---|---|---|---|
| ZNPE (pph) | 60 | 60 | 60 |
| IPN30 (pph) | | 10 | 30 |
| SEBS (pph) | 40 | 30 | 10 |
| FA (pph) | 16.5 | 16.5 | 16.5 |
| ANTIOX (pph) | 0.2 | 0.2 | 0.2 |
| Zinc Oxide | 0.22 | 0.22 | 0.22 |
| Procoess Oil | 0.3 | 0.3 | 0.3 |
| OX (pph) | 1.4 | 1.4 | 1.25 |
| Color Concentrate | 2.0 | 2.0 | 2.0 |
| Density (pcf) | 1.6 | 1.5 | 1.6 |
| Tensile (psi) | 28 | 34 | 24 |
| Elongation (%) | 475 | 321 | 146 |
| 25% C-D (psi) | 2.9 | 3.7 | 4.7 |
| 50% C-D (psi) | 8.8 | 10.5 | 11.4 |
| Tear (pli) | 6 | 6 | 4 |

The data demonstrate the desirable combination of physical properties, particularly the increased compression-deflection values, obtained using the foamed polymer composition according to the invention.

### Example 4

The samples in the following table were prepared as described in Example 1 and demonstrate the effect of the interpenetrating network polymer on expanded polymer compositions according to the invention containing blends of polyethylene and EPDM or EMA.

| | Sample 11 | Sample 12 | Sample 13 | Sample 14 | Sample 15 | Sample 16 |
|---|---|---|---|---|---|---|
| ZNPE (pph) | 70 | 70 | 70 | 70 | 60 | 60 |
| IPN30 (pph) | | 15 | | 15 | | 10 |
| EPDM (pph) | 30 | 15 | 30 | 15 | | |
| EMA (pph) | | | | | 40 | 30 |
| FA (pph) | 16.5 | 16.5 | 10.5 | 10.5 | 16.5 | 16.5 |
| ANTIOX (pph) | 0.2 | 0.2 | 0.2 | 0.2 | 0.2 | 0.2 |
| Zinc Oxide | 0.22 | 0.22 | 0.22 | 0.22 | 0.16 | 0.17 |
| Process Oil | 0.3 | 0.3 | 0.3 | 0.3 | 0.3 | 0.3 |
| OX (pph) | 1.4 | 1.4 | 1.4 | 1.4 | 1.5 | 1.4 |
| Color Concentrate | 2.0 | 2.0 | 2.0 | 2.0 | 2.0 | 2.0 |
| Density (pcf) | 1.5 | 1.5 | 2.2 | 2.3 | 1.6 | 1.6 |
| Tensile (psi) | 37 | 35 | 62 | 59 | 26 | 23 |
| Elongation (%) | 238 | 169 | 292 | 208 | 290 | 202 |
| 25% C-D (psi) | 4.1 | 5.1 | 6.7 | 9.0 | 4.4 | 4.7 |
| 50% C-D (psi) | 10.7 | 12.0 | 14.2 | 16.4 | 10.7 | 11.5 |
| Tear (pli) | 6 | 6 | 11 | 10 | 6 | 5 |

The data demonstrate the desirable combination of physical properties, particularly the increased compression-deflection values, obtained using the foamed polymer composition according to the invention.

### Example 5

The samples in the following table were prepared as described in Example 1 and demonstrate the effect of varying the components in the expanded polymer compositions according to the invention.

| | Sample 17 | Sample 18 | Sample 19 | Sample 20 | Sample 21 | Sample 22 | Sample 23 |
|---|---|---|---|---|---|---|---|
| ZNPE (pph) | 42 | 35 | | | | 70 | |
| SSCPE (pph) | | | | | | | 20 |
| EVA (pph) | | | 59 | 70 | 59 | | 56 |
| IPN30 (pph) | 42 | 35 | 25 | 30 | 25 | 30 | 24 |
| EPDM (pph) | 16 | 30 | 16 | | 16 | | |
| FA (pph) | 8.0 | 9.0 | 8.5 | 8.5 | 8.5 | 3.0 | 8.5 |
| ANTIOX (pph) | 0.5 | 0.5 | 0.5 | 0.5 | 0.5 | 0.5 | 0.5 |
| Zinc Oxide | 0.10 | 0.1 | 0.15 | 0.15 | 0.15 | | 0.15 |
| Zinc Stearate | | | | | | 0.5 | |
| Process Oil | 0.3 | .03 | 0.3 | 0.3 | 0.3 | 0.3 | 0.3 |
| OX (pph) | 1.25 | 1.25 | 1.65 | 1.65 | 1.65 | 1.4 | 1.65 |
| Color Concentrate | 2.7 | 2.7 | 2.7 | 2.7 | 2.7 | 2.7 | 2.7 |
| Density (pcf) | 3.8 | 3.3 | 3.2 | 3.5 | 3.7 | 6.6 | 3.2 |
| Tensile (psi) | 135 | 89 | 89 | 83 | 78 | 156 | 75 |
| Elongation (%) | 228 | 239 | 197 | 236 | 299 | 125 | 210 |
| 25% C-D (psi) | 18.8 | 10.3 | 10.9 | 17.5 | 12.5 | 48.4 | 14.6 |
| 50% C-D (psi) | 29.2 | 17.6 | 20 | 28.3 | 22.1 | 66 | 24 |
| Tear (pli) | 27 | 15 | 11 | 15 | 14 | 30 | 16 |

The data demonstrate the desirable combination of physical properties, obtained using the foamed polymer composition according to the invention.

### Example 6

The samples in the following table were prepared using radiation curing methods demonstrate producing the expanded polymer compositions according to the invention using that method.

The compositions in the table below were prepared in a three step process. In the first step, the resin blend was extruded through a flat die at a rate of approximately 200 pounds per hour at a temperature of approximately 135° C. A continuous sheet of unfoamed polymer blend containing the thermally decomposable chemical foaming agent was produced at a thickness of approximately 0.030 inches and a width of approximately 23 inches. In the second step the sheet was exposed to an electron beam irradiation at a dose of approximately 11 Mrad (rad=Radiation Absorbed Dose; 1 rad is equivalent to 0.01 gray (Gy)) that had the effect of crosslinking the sheet. In the third step, the continuous sheet was fed to a foaming oven in which heat was controlled using a combination of hot air and infrared electrical heaters. The sheet was heated to a temperature above the decomposition temperature of the foaming agent—approximately 200° C.—which had the effect of foaming the sheet. The expanded sheet had dimensions of approximately 60 inches and a thickness of approximately 0.080 inches.

| | Sample 24 | Sample 25 | Sample 26 | Sample 27 | Sample 28 |
|---|---|---|---|---|---|
| Precompounded resins: | | | | | |
| ZNPE (pph) | | 30 | | | |
| LDPE (pph) | 30 | | 30 | 42 | 22 |
| LLDPE (pph) | 20 | 20 | | | 20 |
| IPN30 (pph) | 50 | 50 | | | |
| IPN50 (pph) | | | 70 | | |
| IPN73 (pph) | | | | 58 | 58 |
| Extrusion blend | | | | | |
| Precompounded resin above | 61.8 | 61.8 | 61.8 | 61.8 | 59.6 |
| Foaming agent compound | 30.8 | 30.8 | 30.8 | 30.8 | 33.0 |
| 30% FA in EVA | | | | | |
| Zinc activator compound - | 6.5 | 6.5 | 6.5 | 6.5 | 6.5 |
| 30% in LDPE | | | | | |
| Blue color concentrate | 0.9 | 0.9 | 0.9 | 0.9 | 0.9 |
| Density (pcf) | 2.7 | 3.1 | 3.3 | 2.8 | 2.6 |
| Tensile MD (psi) | 96 | 101 | 92 | 99 | 111 |
| Tensile TD (psi) | 67 | 85 | 80 | 69 | 83 |
| Elongation MD (%) | 98 | 115 | 106 | 117 | 169 |
| Elongation TD (%) | 113 | 100 | 104 | 94 | 131 |
| 25% C-D (psi) | 7.2 | 9.5 | 9.6 | 8.8 | 7.2 |
| 50% C-D (psi) | 17.6 | 21.1 | 21.4 | 19.3 | 17.2 |
| Tear MD (pli) | 16 | 15 | 14 | 18 | 20 |
| Tear TD (pli) | 11 | 13 | 12 | 10 | 11 |

The data demonstrate the desirable combination of physical properties, obtained using the foamed polymer composition according to the invention.

### Example 7

The samples in the following table were prepared as described in example 1 and demonstrate producing expanded polymer compositions according to the invention.

| | Sample 29 | Sample 30 |
|---|---|---|
| LDPE (pph) | 70 | 70 |
| IPN30 (pph) | 30 | 30 |
| FA (pph) | | |
| ANTIOX (pph) | | |
| FA (pph) | | |
| OX (pph) | | |
| Density (pcf) | 1.7 | 3.7 |
| Tensile (psi) | 52 | 74 |
| Elongation (%) | 100 | 126 |
| 25% C-D (psi) | 8.9 | 35.2 |
| 50% C-D (psi) | 17.2 | 47.1 |
| Tear (pli) | 9 | 15 |

The data demonstrate the desirable combination of physical properties, obtained using the foamed polymer composition according to the invention.

The present invention has been described with reference to specific details of particular embodiments thereof. It is not intended that such details be regarded as limitations upon the scope of the invention except insofar as and to the extent that they are included in the accompanying claims.

What is claimed is:

1. A polymer composition comprising:
(a) a first polyolefin polymer; and
(b) an interpenetrating network polymer comprising,
(i) a second polyolefin polymer present in an amount of from 10 percent by weight to 80 percent by weight, based on total weight of said interpenetrating network polymer, and
(ii) a vinyl aromatic polymer present in an amount of from 20 percent by weight to 90 percent by weight, based on total weight of said interpenetrating network polymer,
wherein, as initially provided in said polymer composition, said interpenetrating network polymer is substantially free of crosslinking,
wherein said polymer composition is at least partially crosslinked.

2. The polymer composition according to claim 1, wherein the first polyolefin comprises one or more polymers selected from the group consisting of homopolymers of any C₂-C₈ linear or branched α-olefin; copolymers of ethylene and C₃-C₈ α-olefins; copolymers of C₂-C₈ linear or branched α-olefins and vinyl acetate; copolymers of one or more C₂-C₈ linear or branched α-olefins and C₁-C₈ linear or branched alkyl esters of (meth)acrylic acid; and combinations thereof.

3. The polymer composition according to claim 1, wherein the first polyolefin comprises a copolymer of ethylene and ethyl (meth)acrylate.

4. The polymer composition according to claim 1, wherein the first polyolefin comprises a copolymer of ethylene and vinyl acetate.

5. The polymer composition according to claim 1, wherein the first polyolefin comprises a combination of two or more polymers selected from the group consisting of ethylene homopolymers, copolymers of ethylene and C₃-C₈ α-olefins, copolymer of ethylene and ethyl (meth)acrylate, copolymers of ethylene and vinyl acetate, and combinations thereof.

6. The polymer composition according to claim 1, wherein the melt index of the first polyolefin is from about 0.1 to about 35 g/10 minutes, as determine according to ASTM D 1238 (190° C./2.16 Kg).

7. The polymer composition according to claim 1, wherein the melt index of the first polyolefin is less than 1 g/10 minutes, as determine according to ASTM D 1238 (190° C./2.16 Kg).

8. The polymer composition of claim 1 comprising an elastomeric polymer.

9. The polymer composition of claim 8, wherein said elastomeric polymer is selected from the group consisting of natural rubbers, nitrile rubbers, butyl rubbers, polysulfide rubbers, silicone rubbers, styrene-butadiene rubbers, halosilicone rubbers, polyurethane rubbers, thermoplastic olefin rubbers, ethylene-propylene-diene copolymers (EPDM), polyisoprene, oxirane based elastomers, vinyl aromatic-alkyldiene block copolymers, styrene-ethylene-butylene-styrene block copolymers, polyhaloprenes, fluoropolymers and combinations thereof.

10. The polymer composition of claim 8, wherein said elastomeric polymer is selected from the group consisting of ethylene-propylene-diene copolymers, vinyl aromatic-alkyldiene block copolymers and combinations thereof.

11. The polymer composition of claim 1, wherein said second polyolefin polymer of said interpenetrating network polymer is a second polyethylene polymer.

12. The polymer composition of claim 11, wherein said second polyethylene polymer is prepared from ethylene and a comonomer selected from the group consisting of vinyl acetate, C₃-C₂₀ α-olefin, C₁-C₈ linear or branched alkyl esters of (meth)acrylic acid; maleic anhydride, dialkyl esters of maleic acid, vinyl aromatic monomers, and combinations thereof.

13. The polymer composition of claim 12, wherein said comonomer is selected from the group consisting of vinyl acetate, C₃-C₈ α-olefin, C₁-C₈ linear or branched alkyl esters of (meth)acrylic acid, and combinations thereof.

14. The polymer composition of claim 1, wherein said vinyl aromatic polymer of said interpenetrating network polymer is prepared from a vinyl aromatic monomer composition comprising,
a vinyl aromatic monomer present in an amount of
from 70 percent by weight to 99 percent by weight, based on total weight of said vinyl aromatic monomer composition, and
a comonomer present in an amount of from 1 percent by
weight to 30 percent by weight, based on total weight of said vinyl aromatic monomer composition.

15. The polymer composition of claim 14, wherein said vinyl aromatic monomer is selected from the group consisting of styrene, α-methylstyrene, para-methylstyrene, ethylstyrene, chlorostyrene, bromostyrene, vinyltoluene, vinylbenzene, isopropylxylene and combinations thereof.

16. The polymer composition of claim 14 wherein said comonomer, of said vinyl aromatic monomer composition, comprises at least one member selected from the group consisting of C₁-C₈ linear or branched alkyl esters of (meth)acrylic acid.

17. The polymer composition of claim 14 wherein said vinyl aromatic monomer is styrene and said comonomer is butyl acrylate.

18. The polymer composition of claim 1 wherein said polymer composition has a crosslink density of from 20 to 60 percent by weight, based on total weight of said polymer composition.

19. The polymer composition of claim 1 wherein said polymer composition is crosslinked by a crosslinking agent selected from at least one organic peroxide.

20. The polymer composition of claim 19 wherein said organic peroxide is selected from the group consisting of dicumylperoxide, 2,5-dimethyl-2,5-di(t-butylperoxy)-hexane, 2,5-dimethyl-2,5-di(t-butylperoxy)hexyne-3,1,-bis(t-butylperoxy)-3,3,5-trimethyl cyclohexane, 2,4-dichlorobenzoyl peroxide, 2,5-dimethylhexane-2,5-di(peroxy)benzoate, 1,3-bis(t-butylperoxyisopropyl)benzene, 2,5-dimethyl-2,5-di(peroxybenzoyl)hexyne, 1,1-di-(t-butylperoxy)-cyclohexane, 2,2′-bis(t-butylperoxy)diisopropylbenzene, 4,4′-bis(t-butylperoxy)butylvalerate, t-butylperbenzoate, t-butylperterephthalate, t-butylperoxide and combinations thereof.

21. The polymer composition of claim 1 wherein said polymer composition is crosslinked by exposure of said polymer composition to a high energy radiation source.

22. The polymer composition of claim 1 wherein said first polyolefin polymer is present in an amount of from 30 to 90 percent by weight, and said interpenetrating network polymer is present in an amount of from 10 to 70 percent by weight, in each case the percent weight being based on the total weight of said polymer composition.

23. An expandable polymer composition comprising:
(a) a first polyolefin polymer; and
(b) an interpenetrating network polymer comprising,
(i) a second polyolefin polymer present in an amount of from 10 percent by weight to 80 percent by weight, based on total weight of said interpenetrating network polymer, and
(ii) a vinyl aromatic polymer present in an amount of from 20 percent by weight to 90 percent by weight, based on total weight of said interpenetrating network polymer,
wherein, as initially provided in said expandable polymer composition, said interpenetrating network polymer is substantially free of crosslinking; and
(c) an expansion agent selected from the group consisting of physical expansion agents, chemical expansion agents and combinations thereof,
wherein said expandable polymer composition is at least partially crosslinked.

24. The expandable polymer composition of claim 23, wherein said physical expansion agent is selected from the group consisting of aliphatic hydrocarbon, cycloaliphatic hydrocarbon, halogenated hydrocarbon and combinations thereof.

25. The expandable polymer composition of claim 23, wherein said physical expansion agent is selected from the group consisting of propane, butane, pentane, hexane, cyclobutane, cyclopentane, methyl chloride, ethyl chloride, methylene chloride, trichlorofluoromethane, dichlorofluoromethane, dichlorodifluoromethane, chlorodifluoromethane, dichlorotetrafluoroethane and combinations thereof.

26. The expandable polymer composition of claim 23 wherein said expansion agent is said chemical expansion agent which is selected from the group consisting of azo compounds, N-nitroso compounds, semicarbazides, sulfonyl hydrazides, carbonates, bicarbonates and combinations thereof.

27. An expanded polymer composition comprising:
(a) a first polyolefin polymer; and
(b) an interpenetrating network polymer comprising,
(i) a second polyolefin polymer present in an amount of from 10 percent by weight to 80 percent by weight, based on total weight of said interpenetrating network polymer, and
(ii) a vinyl aromatic polymer present in an amount of from 20 percent by weight to 90 percent by weight, based on total weight of said interpenetrating network polymer,
wherein, as initially provided in said expanded polymer composition, said interpenetrating network polymer is substantially free of crosslinking,
wherein said expanded polymer composition is at least partially crosslinked, and has a density of from 16 to 400 Kg/m³.

28. The expanded polymer composition of claim 27, wherein said expanded polymer composition has a crosslink density of from 20 to 60 percent by weight, based on total weight of said expanded polymer composition.

29. An article of manufacture comprising the expanded polymer composition according to claim 27.

30. The article of manufacture according to claim 29, wherein the article is selected from the group consisting of films, sheets, multilayer films including one or more nonpolymeric layers, multilayer sheets including one or more nonpolymeric layers, personal protective articles, internal cabin structures, floor underlayments, sound insulating articles, toys, yoga mats, gaskets, and shoe parts.

31. An expanded polymer composition comprising:
(a) from 30 to 90 percent by weight based on the expanded polymer composition of a first polyolefin polymer selected from the group consisting of ethylene homopolymers, copolymers of ethylene and C₃-C₈ α-olefins, copolymer of ethylene and ethyl (meth)acrylate, copolymers of ethylene and vinyl acetate, and combinations thereof; and
(b) from 10 to 70 percent by weight based on the expanded polymer composition of an interpenetrating network polymer comprising,
(i) a second polyolefin polymer present in an amount of from 10 percent by weight to 80 percent by weight, based on the weight of said interpenetrating network polymer, and
(ii) a vinyl aromatic polymer present in an amount of from 20 percent by weight to 90 percent by weight, based on the weight of said interpenetrating network polymer;
wherein said second polyolefin is selected from the group consisting of ethylene homopolymers, copolymers of ethylene and vinyl acetate, copolymers of ethylene and C₃-C₈ α-olefins, copolymers of ethylene and C₁-C₈ linear or branched alkyl esters of (meth)acrylic acid, and combinations thereof; and
wherein said vinyl aromatic polymer is selected from the group consisting of polystyrene, copolymers of styrene and C₁-C₈ linear or branched alkyl esters of (meth)acrylic acid, and combinations thereof; and
wherein said expanded polymer composition is at least partially crosslinked and has a crosslink density of from 20 to 60 percent by weight, based on the weight of said expanded polymer composition; and
wherein said expanded polymer composition has a density of from 16 to 400 Kg/m³.

32. An article of manufacture comprising the expanded polymer composition according to claim 31.

33. The article of manufacture according to claim 32, wherein the article is selected from the group consisting of films, sheets, multilayer films including one or more nonpolymeric layers, multilayer sheets including one or more nonpolymeric layers, personal protective articles, internal cabin structures, floor underlayments, sound insulating articles toys, yoga mats, gaskets, and shoe parts.

34. A method of producing an expanded polymer composition in a shorter period of time comprising:
forming a polymer blend by combining
(a) a first polyolefin polymer;
(b) an interpenetrating network polymer comprising,
(i) a second polyolefin polymer present in an amount of from 10 percent by weight to 80 percent by weight, based on total weight of said interpenetrating network polymer, and
(ii) a vinyl aromatic polymer present in an amount of from 20 percent by weight to 90 percent by weight, based on total weight of said interpenetrating network polymer,
(c) one or more crosslinking agents; and
(d) one or more foaming agents;
forming a first foamed polymer composition by placing the polymer blend in a press at a temperature of from 240 to 320° F. and 250 to 2,500 psi for 20 to 90 minutes; and
forming a final foamed polymer composition by placing the first foamed polymer composition in a press at a temperature of from 300 to 380° F. and 250 to 1,500 psi for 15 to 320 minutes;
wherein the cycle time required to produce the present expanded polymer composition is at least 5% less than the time required to produce an expanded composition containing the same ingredients as the present expanded polymer composition except for the interpenetrating network polymer.
